(19) United States
(12) Patent Application Publication
(10) Pub. No.: US 2012/0003135 A1
(43) Pub. Date: Jan. 5, 2012

(54) WATER TREATMENT

(76) Inventors: Nicholas Vollendorf, New Berlin, WI (US); Eric Fessler, Brookfield, WI (US); Mark Pronley, Wauwatosa, WI (US); Erik L. Storvik, Grafton, WI (US)

(21) Appl. No.: 13/142,611

(22) PCT Filed: Jan. 4, 2010
(86) PCT No.: PCT/US10/20038

§ 371 Date: Sep. 20, 2011

Related U.S. Application Data
(60) Provisional application No. 61/142,295, filed on Jan. 2, 2009.

(51) Int. Cl. C02F 1/52; C01F 13/00; C01B 5/00; C02F 101/10; C02F 101/20

(52) U.S. Cl. 423/249; 210/709; 210/715; 210/710; 423/580.1

(57) ABSTRACT

Methods of treating water, methods of removing radium from water, methods for controlling the amount of at least one target element removed from water and the amount of at least one target element in a pellet, a pellet and treated water. The method may generally include providing water including a principal ion and a target element, contacting the water with a fluidized bed, the fluidized bed including seed material, and controlling at least one of a type and a size of the seed material to remove principal ion and target element from the water. The target element may include radium. The principal ion may include calcium, magnesium, etc. A pellet may include a seed material, radium carbonate crystals, and calcium carbonate crystals

### CROSS-REFERENCE TO RELATED APPLICATION

This application claims priority under 35 U.S.C. §119(e) to U.S. Provisional Patent Application Ser. No. 61/142,295, filed Jan. 2, 2009, the entire contents of which is hereby incorporated by reference.

### SUMMARY

Water is a scarce resource that has growing demand and diminishing supply. As the population continues to increase and demand for energy, fuel, and food increase, so will the demand for water for potable municipal supply, energy and domestic fuel production, and the agricultural and food industries. Water supplies that were previously avoided due to water quality issues will become a necessary resource of water. These include aquifer water supplies that are contaminated with various elements, including radioactive elements (e.g., radium, uranium, etc.). Currently, use of these abundant supplies of water is commonly limited or altogether avoided due to the cost, risk, and liability of managing the water containing the undesirable elements.

With respect to radioactive elements, existing radium removal technologies produce waste in the form of 10-20% wasted water and solid waste that is either disposed of on the land, in a landfill, or in a licensed radioactive waste disposal facility. Existing radioactive removal technologies include conventional cold or hot lime softening, hydrous manganese oxide (“HMO”), resin ion exchange, and reverse osmosis.

Cold or hot lime softening requires substantial facilities and labor to manage the huge quantities of waste sludge produced in the process. Approximately 1-2 tons of waste, commonly consisting of 50% water, is generated for every one million gallons of water treated. This sludge is ultimately hauled offsite and disposed of on the land or in landfills.

The HMO process also removes the radium as sludge; however, the waste radium is commonly discharged to the sanitary sewer along with wastewater to dilute the waste to below enforcement levels. The radium-containing sludge is then handled by the municipal wastewater treatment facility and disposed of again either on the land or in a landfill.

Resin ion exchange systems capture the radium cations on the resin removing the radium from the water. Routinely, the resin is then regenerated with salt (e.g., sodium chloride), discharging the radium-bearing wastewater to the sanitary sewer along with chlorides (1-2 million pounds per year for each one million gallons per day treated). In addition, when the resin requires replacement, the resin must be disposed of in a licensed radioactive storage and disposal facility.

Reverse osmosis systems remove the radium along with other ions by producing permeate (60-80%) that passes through the reverse osmosis membrane and concentrate (brine) (20-40%) wastewater that is retained by the reverse osmosis membrane. The brine wastewater contains up to 5 times the radium concentration that commonly requires wastewater treatment or disposal.

A sustainable method of producing safe, potable water from water sources contaminated with various undesirable elements is necessary to allow that vast available supply of water to be utilized to meet growing water demand and limited water supply.

In one independent aspect, the present application may provide a method of treating water containing one or more target elements and in need of treatment. The water may be contacted with a seed material in a fluidized bed. At least one reagent may be introduced to the water. The type and size of the seed material may be controlled to remove at least one target element from the water. The type and amount of reagent introduced may be controlled to remove the at least one target element from the water. At least one reagent may be introduced to the water before the water enters the fluidized bed so as to have a substantially complete heterogeneous nucleation take place on the seed material. The fluidized bed may be a fluidized bed of grains. The seed material may be a natural or an engineered seed material. Natural seed materials may include, without limitation, natural sands, mineral pellets produced using pellet reactor technology, and combinations thereof. Natural sands may include, for example, quartz, limestone, dolomite, sea shells, and combinations thereof. Engineered seed materials may include, without limitation, chemically-modified sands or mineral pellets, synthetic materials, and combinations thereof. Chemically-modified sands or mineral pellets may be, without limitation, sands or mineral pellets treated with chemical coatings and/or chemical functionalization designed to enhance the effectiveness of the sands as seed material. Synthetic materials may include, without limitation, silica gels, aluminas, zeolites, chemically-modified derivatives of these materials, and combinations thereof.

In another independent aspect, the present application may provide a method for removing at least one target element from water. At least one reagent may be added to water to form a crystalline difficultly soluble salt. The water may be contacted with a bed of grains of seed material seed that promotes crystallization. The bed may be fluidized and kept in fluidization by a water stream. The type and size of the seed material may be controlled to remove at least one target element from the water. The type and amount of reagent added may be controlled to remove at least one target element from the water.

In some aspects, calcium or magnesium may be crystallized from the water on a nano-scale to form a calcium or magnesium, respectively, carbonate crystalline lattice. At least one target element may be incorporated into the carbonate crystalline lattice.

In some aspects, the method may produce a pellet comprising at least one of a seed material, target element carbonate crystals, crystals of other target elements, and principal ion carbonate crystals. The target element concentrations of the pellet may be controlled to be within acceptable use standards by controlling seed material type and size, reagent dosing levels, and combinations thereof.

In some cases, the target element concentration in the treated water may be at least about 40% less than, at least about 60% less than, or at least about 95% less than the target element concentration in the water.

In another independent aspect, the present application may provide a method for chemical reduction of a dissolved radioactive content of a stream of water containing the dissolved radioactive content. A stream of water may be passed through a bed of seed grains. The type and size of the seed grains may be controlled to remove radioactive cations from the water. The bed of seed grains may be fluidized by the passing stream. At least one reagent may be provided which will react with the dissolved radioactive content to form crystals of a radioactive compound. The type and amount of reagent may be controlled to remove radioactive cations from the water. Granules of crystalline material may be obtained by crystallization and build-up of the radioactive compound onto the seed grains, the granules being readily separated from the stream as virtually water-free granules.

In another independent aspect, the present application may provide a method for removing radioactive cations from water. Radioactive cations may be removed as part of a pellet by-product using a fluidized bed reactor. Calcium or magnesium may be crystallized from water on a nano-scale to form a self-dewatering calcium or magnesium, respectively, carbonate ceramic pellet. Radioactive cations may be incorporated into a calcium or magnesium, respectively, carbonate crystalline lattice to remove radioisotopes from water.

In some aspects, water may be treated with a fluidized bed reactor to produce treated water. In some cases, the radioactive cation concentration in the treated water may be at least about 40% less than, at least about 60% less than, or at least about 95% less than the radioactive cation concentration in the water.

In another independent aspect, the present application may provide a method for controlling the amount of at least one target element removed from water and the amount of at least one target element in a pellet, the method comprising controlling material and size of a seed used as a pellet nucleus, chemical reagent dosing, and combinations thereof.

In another independent aspect, the present application may provide a pellet comprising about 70% to about 95% of at least one principal ion carbonate lattice incorporating at least one target element within acceptable use standards and about 5% to about 30% of seed material, moisture, and trace materials.

In another independent aspect, the present application may provide a method for removing radium from water. Water may be treated with a fluidized bed reactor to produce treated water having a combined activity from Ra-226 and Ra-228 of less than about 5 pCi/L.

In another independent aspect, the present application may provide a method for controlling the amount of at least one target element removed from water and the amount of at least one target element in a pellet. A desired concentration of target element cation A in the pellets, Aₚ, may be selected and a fraction of the pellet weight formed from a seed material fₛ and a fraction of the pellet weight formed from chemical reagents f_{c} may be controlled by using the following formula:

$${f}_{s} + {f}_{c} = 1 - \frac{{A}_{p} {C}_{Ca \text{/} Mg}}{{B}_{A}} .$$

C_{Ca/Mg} is volumetric calcium or magnesium concentration in the water, and B_{A} is the concentration of the target element in the water.

In another independent aspect, the activity in pellets that results from crystallization from water may be diluted by starting with a large seed and/or causing additional crystallization from added chemistry. In one example, radium may be removed from water, and the safety of the pellet produced may be controlled so the activity is within acceptable limits.

In a further independent aspect, radioactivity may be controlled based on seed size or chemical dosing depending on the influent water.

In another independent aspect, the present application may provide a method of treating water, and the method may generally include providing water including a principal ion and a target element, contacting the water with a fluidized bed, the fluidized bed including seed material, and controlling at least one of a type and a size of the seed material to remove the principal ion and the target element from the water.

In some aspects, the providing act may include doping the water with principal ion. The doping act may include, before the contacting act, doping the water with an amount of principal ion. The doping act may include doping the water with an amount of principal ion in the fluidized bed. The method may further include removing the doped principal ion.

In some aspects, the method may further include introducing a reagent to the water, and controlling at least one of a type and an amount of the reagent introduced to remove the target element from the water. The introducing act may include, before the contacting act, introducing a reagent to the water so as to have a substantially complete heterogeneous nucleation take place on the seed material. The introducing act may include introducing a reagent to the water in the fluidized bed.

In some aspects, the introducing act may include introducing a reagent to the water at a first level (or elevation) in the fluidized bed, and introducing a reagent to the water at a second level (or higher elevation) in the fluidized bed. The reagent introduced to the water at the first level may be the same as the reagent introduced to the water at the second level. The reagent introduced to the water at the first level may be different than the reagent introduced to the water at the second level.

In some aspects, the method may further include discharging treated water having a concentration of the target element, determining whether the concentration of the target element in the treated water is above a threshold, and if the concentration of the target element in the treated water is above the threshold, recirculating the water to the fluidized bed for further treatment until the concentration of the target element is one of equal to and less than the threshold.

In some aspects, the method may further include crystallizing the principal ion from the water on a nano-scale to form a principal ion carbonate crystalline lattice, resulting in the target element being incorporated into the principal ion carbonate crystalline lattice. The target element may include radium, the radium being incorporated into the principal ion carbonate crystalline lattice. The crystallizing act may include producing a pellet including a seed material, target element carbonate crystals, and principal ion carbonate crystals. The target element may include radium, and the pellet may include radium carbonate crystals. The fluidized bed may be provided in a reactor vessel, and the method may further include removing pellets from the reactor. The method may further include adding seed material to the fluidized bed.

In some aspects, the target element may include radium. The method may further include discharging treated water having a combined activity from Ra-226 and Ra-228 of less than about 5 pCi/L. The method may further include discharging treated water having a radium concentration at least about 90% less than a radium concentration in the water.

In some aspects, the principal ion may include calcium. The method may further include crystallizing calcium from the water on a nano-scale to form a calcium carbonate crystalline lattice, the target element being incorporated into the calcium carbonate crystalline lattice. The target element may include radium, the radium being incorporated into the calcium carbonate crystalline lattice. In some aspects, the principal ion may include magnesium.

In another independent aspect, the present application may provide a method of removing radium from water, and the method may generally include contacting water including radium with a fluidized bed, the fluidized bed including a seed material, and controlling at least one of a type and a size of the seed material to remove radium from the water.

In some aspects, the method may further include introducing a reagent to the water, and controlling at least one of a type and an amount of the reagent introduced to remove radium from the water. The introducing act may include introducing a reagent to the water at a first level in the fluidized bed, and introducing a reagent to the water at a second level in the fluidized bed.

In some aspects, the method may further include discharging treated water having a concentration of radium, determining whether the concentration of radium in the treated water is above a threshold, and if the concentration of radium in the treated water is above the threshold, recirculating the water to the fluidized bed for further treatment until the concentration of radium is one of equal to and less than the threshold. The method may further include discharging treated water having a combined activity from Ra-226 and Ra-228 of less than about 5 pCi/L. The method may further include discharging treated water having a radium concentration at least about 90% less than a radium concentration in the water.

In some aspects, the water may also include calcium, and the controlling act may include controlling at least one of a type and a size of the seed material to remove calcium from the water. The method may further include adding calcium to the water. The method may further include crystallizing calcium from the water on a nano-scale to form a calcium carbonate crystalline lattice, radium being incorporated into the calcium carbonate crystalline lattice. The crystallizing act may include producing a pellet including a seed material, radium carbonate crystals, and calcium carbonate crystals. The fluidized bed is provided in a reactor vessel, and the method may further include removing pellets from the reactor.

In another independent aspect, the present application may provide a pellet produced by a process, and the process may generally include contacting water including calcium and radium with a fluidized bed, the fluidized bed including a seed material, controlling at least one of a type and a size of the seed material to remove calcium and radium from the water, and crystallizing calcium from the water on a nano-scale to form a calcium carbonate crystalline lattice, radium being incorporated into the calcium carbonate crystalline lattice, the crystallizing act including producing a pellet including a seed material, radium carbonate crystals, and calcium carbonate crystals.

In another independent aspect, the present application may provide water treated by a process, the treated water having a radium concentration at least about 90% less than a radium concentration in the water before treatment, the treated water having a combined activity from Ra-226 and Ra-228 of less than about 5 pCi/L.

### BRIEF DESCRIPTION OF THE DRAWINGS

FIG. 1 is a schematic illustration of an embodiment of a method of water softening and water treatment.

FIG. 2 is a schematic representation of an embodiment of an apparatus used in the method of water softening and water treatment.

FIG. 3 is a graph showing the test results of Example 1 as compared to the prior art.

FIG. 4 shows the pilot radium removal operating parameters of Example 1.

FIG. 5 shows the pilot radium removal operating parameters of Example 2.

FIG. 6 is a graph referenced in Example 9.

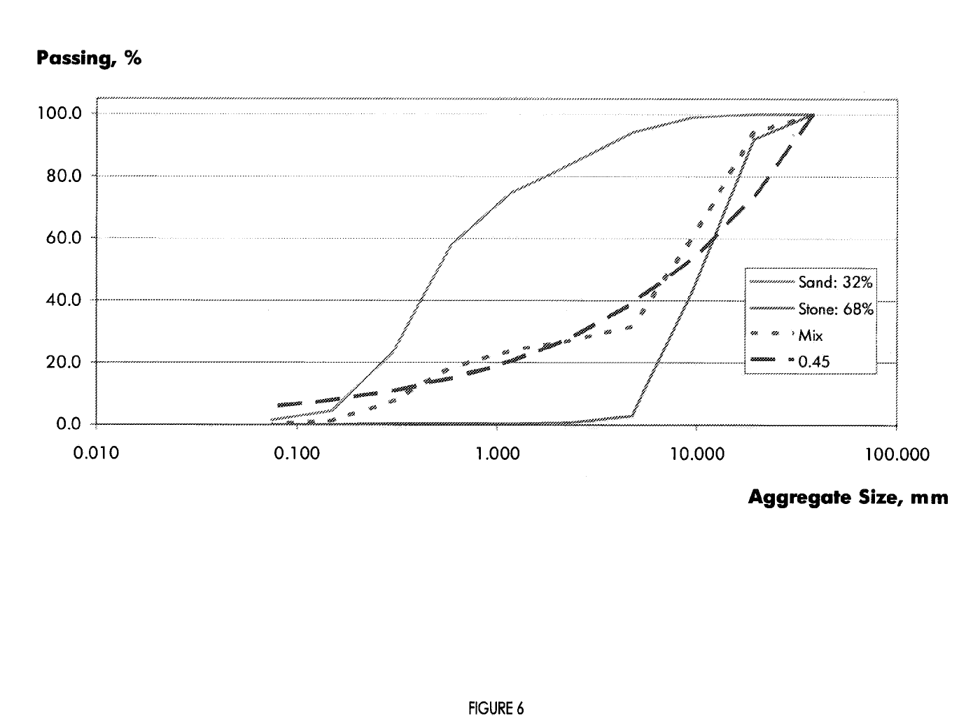

FIG. 7 is a graph referenced in Example 9.

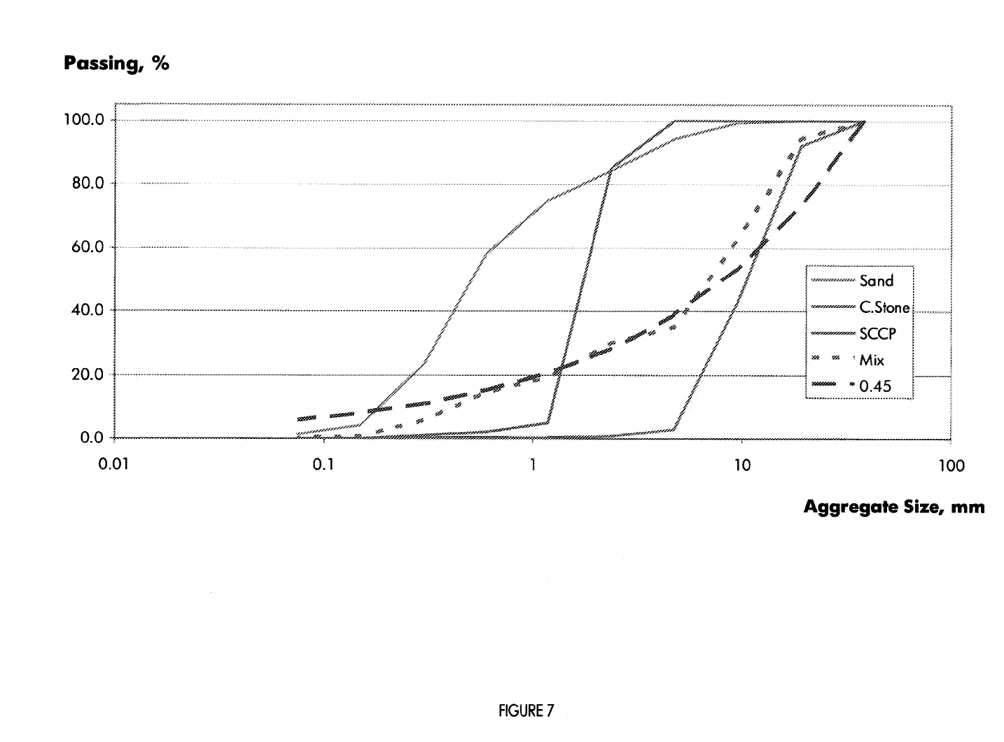

FIG. 8 is a graph referenced in Example 9.

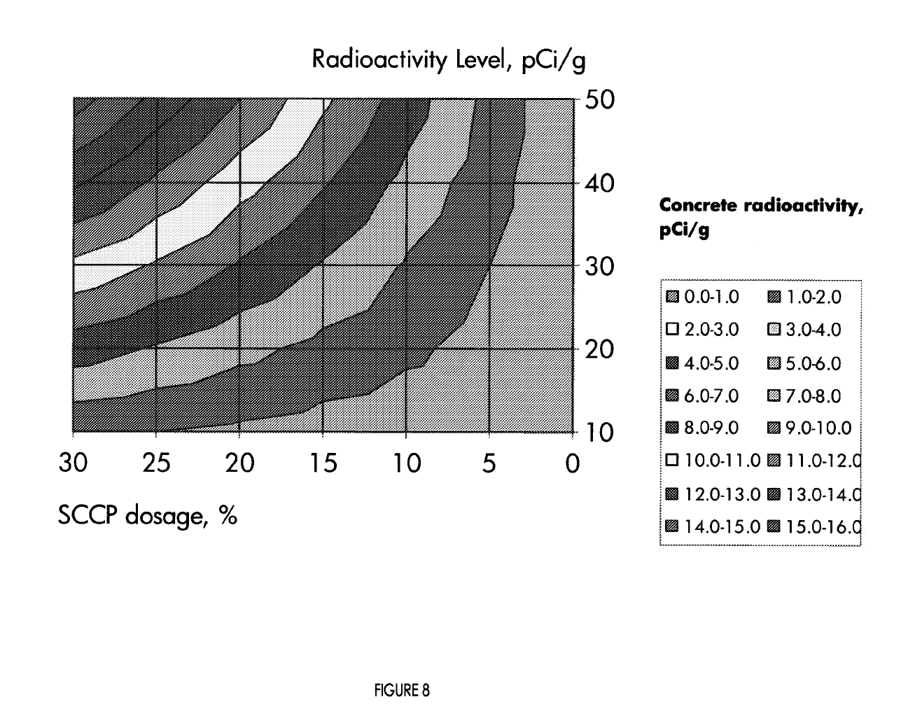

FIG. 9 is a graph referenced in Example 10.

FIG. 10 is a photograph referenced in Example 10.

FIG. 11 includes photographs referenced in Example 10.

FIG. 12 is a graph referenced in Example 10.

FIG. 13 is a graph referenced in Example 10.

Before any independent embodiments or constructions of the present application are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

### DESCRIPTION

As used herein, “target element” means at least one element or ion that is targeted and removed or extracted from water intentionally or that is removed or extracted as part of the method(s) of the present application. A target element may be in trace amounts or in amounts greater than trace amounts. In some independent embodiments, a target element may be a trace element. A target element may be hazardous or not or radioactive or not. A target element may be an element that is removed, purified, and/or refined. Target elements may include, without limitation, radioactive cations (e.g., radium, uranium, thorium, actinium, protactinium, polonium, lead, bismuth, and combinations thereof), manganese, iron, beryllium, strontium, barium, nickel, zinc, and/or mercury or any other transition metal element, and combinations thereof. Removal of these target elements may vary between 0 to about 95%, depending on the mineral, chemical dosing and reactor conditions.

As used herein, the term “principal ion” means at least one principal ion that is removed or extracted from water. A principal ion that is removed from water may be a principal ion in water hardness, a principal ion in crystallization, or a softening ion. Principal ions may include, without limitation, at least one of calcium, magnesium, ammonium, bicarbonate, carbonate, phosphate, and sulfate. The principal ions may form crystalline ionic structures.

As used herein, the term “substantially complete heterogeneous nucleation” means precipitation or crystallization of a salt to, or nearly to, the extent predicted by the equilibrium constant (“Ksp”) for that salt.

In some independent aspects and in some constructions, a method for removing at least one target element from water is provided. In general, the target element is removed from the water by forming a target element crystal that forms within a principal ion crystalline structure. The water quality produced may meet standards for the desired application. The method also removes at least one principal ion from water. Accordingly, in the method, the water may also be softened without the use of chlorides. The method also produces a pellet containing at least one of a seed material (i.e., engineered seed or natural seed) as the pellet nucleus, target element carbonate crystals, crystals of other target elements, and principal ion crystals. The method may control the pellets to contain an amount of at least one target element within or below acceptable use standards for the desired application.

In one embodiment, a method for removing radioactive cations from water is provided. Examples of radioactive cations include, but are not limited to, radium, uranium, thorium, actinium, protactinium, polonium, lead, bismuth, and combinations thereof. One particular radioactive cation of interest is radium. Radium is preferably removed from the water by forming a radium crystal that forms within a calcium or magnesium carbonate crystalline structure. The water quality produced may meet EPA standards for safe drinking water. The water quality produced may meet the requirements of Radionuclides Rule 66 (see, FR 76708 Dec. 7, 2000, Vol. 65, No. 236).

In this embodiment, the method also removes calcium or magnesium from water. Accordingly, in the method, the water is also softened without the use of chlorides. The method produces a pellet containing at least one of an engineered or natural seed as the pellet nucleus and crystals which may be, for example, radium carbonate crystals, crystals of other radioactive cations, and calcium carbonate crystals. The method may result in pellets that contain radioactive concentrations within or below acceptable use standards. The radioactive concentrations of the pellets may be comparable to the concentrations in common materials such as, for example, landscape stone or building materials (e.g., granite).

Water supplies which may contain at least one target element can include, without limitation, ground water, surface water, brine water, and process water from the power industry (e.g., scrubber water from coal-fired power plants and oil and natural gas fired power plants) or from the mining and refining operations (e.g. steel manufacturing and coal, petroleum and natural gas production), food, grain, fat, and oil processing industries, and metal-plating industries.

Such water supplies may require a reduction in the concentration of at least one target element before the water may be used in certain applications or be discharged. For example, radium may be found in connection with calcium hardness in limestone aquifers across the country. As mentioned above, existing methods for removing radium include lime softening that precipitates the radium within the lime sludge, which is supported by the EPA. Pellet reactor softening may be similar to lime softening but on a nano-scale in which calcium carbonate crystals form a self-dewatering crystalline pellet.

In some independent aspects and in some constructions, a pellet reactor is provided to remove at least one target element as part of a pellet by-product. The pellet reactor softening technology crystallizes at least one principal ion from water on a nano-scale to form a self-dewatering principal ion ceramic pellet. The water to be treated may contain at least one principal ion and contains at least one target element.

In embodiments in which the water to be treated contains low concentrations of or no principal ion(s), the water to be treated may be doped with at least one principal ion to enable the target element(s) to be removed using the method(s) of the present application. The water may also be doped with additional amounts of the at least one principal ion even if the water to be treated contains at least one principal ion. Such additional doping may be required to remove the target element(s) or to reduce the concentration to the desired level.

In one example, without limitation, the method may form a self-dewatering limestone (calcium carbonate) ceramic pellet. At least one target element may be incorporated into the at least one principal ion carbonate crystalline lattice to remove the target element(s) from the water. These may be contained in the pellet as a result of the crystallization and pellet reactor softening process.

In some independent aspects in and some constructions, a pellet reactor may be provided to remove at least one principal ion as part of a pellet by-product. The pellet reactor softening technology may crystallize at least one principal ion from water on a nano-scale to form a self-dewatering principal ion ceramic pellet. In one example, without limitation, the pellet reactor may crystallize calcium from water on a nano-scale to form a self-dewatering limestone (calcium carbonate) ceramic pellet. In another example, without limitation, the pellet reactor softening technology may crystallize magnesium from water on a nano-scale to form a self-dewatering magnesium carbonate ceramic pellet.

Pellet reactor softening may be similar to lime softening but on a nano-scale. As opposed to existing lime softening techniques, which produce sludge that has to be managed as waste and wastewater, methods of the present application may produce pellets with little or no wastewater which may have other uses in industry.

With respect to radium removal, the existing lime softening techniques produce sludge which is hazardous waste. In contrast, methods of the present application may produce pellets which are not considered hazardous waste and may have other uses in industry. Treated water may be potable water that may meet water drinking standards. The treated water may also be softened water.

In some independent aspects and in some constructions, a fluidized bed of material is used to treat the water. Specifically, the water is contacted with a seed material in a bed of grains of the seed material, while introducing reagents so as to have a substantially complete heterogeneous nucleation take place on the seed material. The bed may be fluidized and kept in fluidization by a water stream.

A method for chemical reduction of the at least one principal ion and/or at least one target element content of water may also be provided. The method includes adding at least one reagent which forms a crystalline difficultly soluble salt, and contacting the liquid reagent with a seed material to promote the crystallization. The contacting may take place in a bed of grains of the seed material, the bed being fluidized and kept in fluidization by the water stream. As used herein, the term “difficultly” means a range in between insoluble and somewhat soluble.

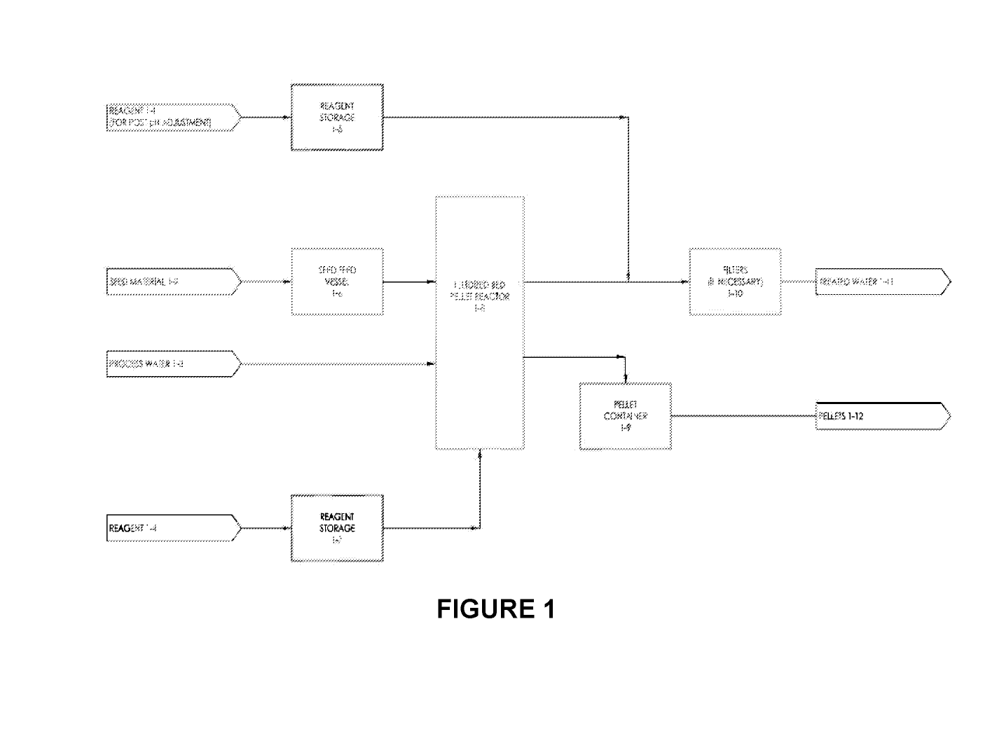

FIG. 1 illustrates one possible embodiment of a method for water softening and/or target element treatment. This embodiment may be particularly adept at removing target elements. The illustrated treatment method includes feeding the process water 1-3 containing at least one target element to the fluidized bed pellet reactor 1-8. In the fluidized bed reactor 1-8, the chemical reagent 1-4 in a storage container 1-7 may be introduced on a continuous basis. After leaving the fluidized bed reactor 1-8, the treated process water 1-11 may be adjusted with another reagent 1-1 in a storage container 1-5 in order to achieve the desired pH. Filters 1-10 may be required to remove amorphous material from the treated water 1-11, depending on performance of the fluidized bed reactor 1-8 and the required effluent quality. Seed material 1-2 may be fed to the fluidized bed reactor 1-8 on a periodic basis. A seed feed vessel 1-6 may be used to introduce the seed material into the fluidized bed reactor 1-8. Pellets 1-12 may be discharged from the fluidized bed reactor 1-8 on a periodic basis. Such pellets 1-12 may be drained and stored in a pellet container 1-9.

The fluidized bed pellet reactor 1-8 may be used to treat the process water 1-3 that may contain at least one target element by crystallizing both the target element(s) and the principal ion(s) onto seed material 1-2. The fluidized bed 1-8 keeps the pellets 1-12 and the seed material 1-2 in a constant state of suspension (fluidization) to mix the process water 1-3, the seed material 1-2, and the chemical reagent 1-4 to promote crystallization of the principal ion(s) and the target element(s) on the seed material 1-2. The seed material 1-2 may be fed to the fluidized bed reactor 1-8 to provide the required substrate to which the crystallization occurs.

The reagent 1-4 may be introduced near the bottom of the reactor 1-8 with nozzles to further promote mixing. The chemical reagent 1-1 or 1-4 may be selected based on the process water 1-3 quality, the desired treated water 1-11 quality, and/or the desired pellet 1-12 quality. The chemical reagent 1-1 may be introduced to halt further reaction outside of the fluidized bed 1-8, to avoid the formation of scale and/or suspended solids, etc. The filters 1-10 may be necessary to remove amorphous material (suspended solids). Amorphous materials may form because the reaction did not occur on the seed material 1-2, but rather occurred in the solution. The pellet container 1-9 may be used to both store the pellets 1-12 formed in the fluidized bed 1-8 and drain away process water 1-3 that may have accompanied the pellets 1-12 during removal.

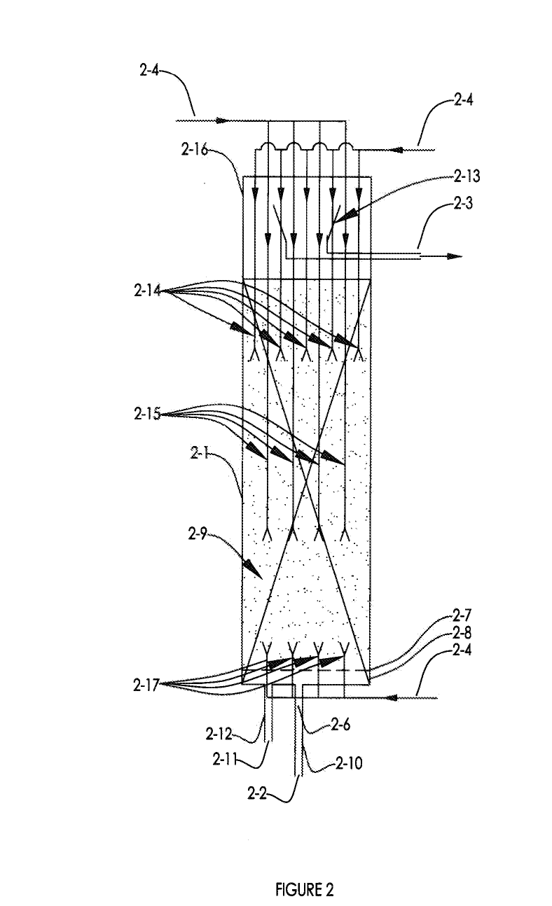

FIG. 2 is an example of a fluidized bed reactor that may be used in the method(s) of the present application. A similar fluidized bed reactor is described in U.S. Pat. No. 4,389,317, the entire contents of which are hereby incorporated by reference. The fluidized bed, or reaction vessel, may be upright in operation. The lower end may include an inlet for crude water and an outlet for the grains comprising the seed material and the compounds crystallized thereon, and the upper end may include an outlet for treated water as well as an inlet for reagent. Spray nozzles may also be provided at different heights above the lower end of the reactor.

Referring to FIG. 2, a reaction vessel 2-1 has water feed duct 2-2, a water discharge duct 2-3 and reagent feed ducts 2-4. The water, which may be mixed with a reagent or reagents, enters the reactor 2-1 through the duct 2-6. The water then flows through the distributing plate 2-7, which is provided just above the reactor bottom 2-8. The distributing plate 2-7 serves to distribute the water current over the complete width of the reactor, thus maintaining a homogenous fluidized bed 2-9 of seed material promoting crystallization.

This fluidized bed 2-9 is kept in the reactor 2-1 and made from the grain filling present therein by virtue of the entering water current, the current velocity of which and, thereby, the height of the fluidized bed can be controlled by the valve 2-10 taken up into the duct 2-6. A discharge 2-11 for grains with a valve 2-12 is incorporated into the reactor bottom. It is possible to inject one or more reagents directly into the reactor by way of reagent spray nozzles 2-17.

In the upper region of the reactor 2-1, an overflow funnel 2-13 may be mounted, which serves as a discharge for the treated water. This funnel 2-13 debouches into the water discharge duct 2-3. A number of lances 2-14 and 2-15 may be mounted in the reactor 2-1 for one or more reagents fed through reagent duct 2-4, which empty at different heights above the bottom into the fluidized bed 2-9. The distance between the end of the lances 2-14 and 2-15 and the cover 2-16 of the reactor 2-1 may be varied.

When the concentration of the target element(s) and/or of the principal ion(s) in the water are too high to treat the water in one pass through the fluidized bed, the water may be recirculated through the fluidized bed. For example, if the principal ion is calcium, and the calcium concentration in the water is between about 170 to about 390 mg/L as Ca ion (or about 450 to about 960 mg/L as CaCO₃), particularly between about 188 to about 375 mg/L as Ca ion (or about 470 to about 938 mg/L as CaCO₃), the water may be recirculated through the fluidized bed.

Alternatively, multiple dosing points within the fluidized bed may be used. The reactor 2-1 may have additional treatment capacity by extending the length of the reactor 2-1 as compared to a reactor of the same diameter, but of a shorter length. By using a longer reactor 2-1, multiple dosing points within the reactor may be used. Therefore, the water may not need to be recirculated. Multiple dosing may also reduce operating costs and increase treatment capacity.

Multiple dosing refers to treating the water with more than one dose of reagent in the same pass through the reactor 2-1. The same reagent may be used, injected at different points or heights in the reactor 2-1. Different reagents may also be used, either injected at the same point(s) or at different points in the reactor 2-1.

The method may commonly use a continuous process. The water chemistry changes as the water moves up the fluidized bed 2-9, so the types of reagents used, as well as the amounts of reagent and dosing points can be adjusted accordingly. The incoming water may be tested to determine, for example, the actual concentration(s) of principal ion(s), of target element(s), of other constituents, and parameters of the process may be adjusted accordingly.

Another embodiment of the reactor does not include lances 2-14 and 2-15. Certain embodiments of the reactor 2-1 may include a secured cover 2-16 to operate the reactor 2-1 under a desired amount of pressure needed for other downstream operations.

To obtain a fluidized bed suitable to the present purpose, the particle size of particles in the bed may be at least about 0.1 mm in diameter, particularly at least about 0.15 mm, suitably at least about 0.20 mm, and desirably at least about 0.30 mm. The particle size of particles in the bed may also be less than about 2.5 mm in diameter and particularly less than about 1.5 mm. The height of the fixed bed, from which the fluidized bed is obtained, may be at least about 2 ft and particularly at least about 3 ft. The height of the fixed bed may also be less than about 10 ft and particularly less than about 6 ft.

The superficial current velocities may be at least about 1.5 ft/min and particularly at least about 2.0 ft/min. The superficial current velocities may also be less than about 6.5 ft/min, particularly less than about 5.0 ft/min, and suitably less than about 3.5 ft/min. Velocities are expressed in linear dimensions, so volumetric capacity is dependent on diameter. Thus, one of skill in the art can determine the values for lab-scale operations, pilot-scale operations, and full-scale operations.

The pH within the fluidized bed reactor may be controlled by dosing an appropriate chemical reagent. In some embodiments, this may be a basic chemical reagent. In some embodiments, the basic chemical reagent can be calcium carbonate. The pH may be at least about 8.0, particularly at least about 8.75, and more particularly at least about 9.0. The pH may also be less than about 10.0, particularly less than about 9.75, and more particularly less than about 9.4.

Natural or engineered seed materials may be used in the fluidized bed. Examples of natural seed materials may include, without limitation, natural sands, mineral pellets produced using pellet reactor technology, and combinations thereof. Natural sands of any composition, for example, without limitation, quartz, limestone, dolomite, sea shells, etc., may be used as seed materials. Mineral pellets produced using pellet reactor technology may include, but are not limited to calcium carbonate (CaCO₃), calcium phosphate (Ca₃(PO₄)₂), magnesium phosphate (Mg₃(PO₄)₂), magnesium carbonate, dicalcium phosphate, struvite (NH₄MgPO₄), and combinations thereof. Examples of engineered seed materials may include, without limitation, chemically-modified sands or mineral pellets, synthetic materials, and combinations thereof. Chemically-modified sands or mineral pellets may be, without limitation, sands or mineral pellets treated with chemical coatings and/or chemical functionalization designed to enhance the effectiveness of the sands as seed material. Synthetic materials may include, without limitation, silica gels, aluminas, zeolites, chemically modified derivatives of these materials, and combinations thereof.

Selection of the seed material may be dependent on the characteristics of the water. In particular, the concentration(s) of the principal ion(s) and the target element(s) within the water will affect the defined parameters of preferred seed material and seed size. The desired target element(s) to be removed can also affect the defined parameters of the seed material and seed size. The original seed size and weight, as well as the end size and weight, may be tailored to control the amount of target element(s) in the end pellet.

In some embodiments, the preferred seed may be a calcium or magnesium carbonate material with diameters of at least about 0.1 mm and particularly of at least about 0.30 mm. The diameters of the calcium or magnesium carbonate material seed may also be less than about 2.5 mm and particularly less than about 1.5 mm. In some embodiments, the seed material may be as small as about 0.1 mm. For example, without limitation, this may occur when the target element to principal ion ratio is low.

In other embodiments, the seed material may be as large as about 2.5 mm. For example, without limitation, this may occur when the target element to principal ion ratio is higher. For example, if the target element concentration of the water is high, by starting with a slightly larger pellet, less target element will be deposited or crystallized onto the pellet. For example, without limitation, to form a pellet that is not as radioactive, or that is radioactive within acceptable limits, when the water to be treated has a high radioactivity content, a larger seed can be used.

Alternatively, to incorporate less target element onto a pellet, the water to be treated can be doped with at least one principal ion. In one example of a seed material that may be used, without limitation, smaller calcium or magnesium carbonate pellets from water softening fluidized bed reactors (used at locations with little to no target element) may be collected for use.

In common cases of radium-contaminated aquifers, a preferred seed may be a calcium carbonate material with diameters of at least about 0.1 mm and particularly of at least about 0.30 mm. The diameters of the calcium carbonate material seed may also be less than about 2.5 mm and particularly less than about 1.5 mm. In some embodiments, the seed material may be as small as about 0.1 mm. For example, without limitation, this may occur when the radium to calcium ratio is low.

In other embodiments, the seed material may be as large as about 2.5 mm. For example, without limitation, this may occur when the radium to calcium ratio is higher. For example, if the radioactive concentration of the water is high, by starting with a slightly larger pellet, less radioactive cations will be removed onto the pellet. For example, without limitation, to form a pellet that is not as radioactive, or that is within acceptable limits for radioactivity, when the water to be treated has a high radioactivity content, a larger seed can be used.

Alternatively, to remove less radioactive cations onto a pellet, the water to be treated can be doped with at least one principal ion. In one example, without limitation, smaller calcium carbonate pellets from water softening fluidized bed reactors (used at locations with little to no radium) may be collected for use.

The method may include adding at least one reagent which forms a crystalline difficultly soluble salt to the fluidized bed reactor. The reagent(s) may be introduced into the water before the water enters the fluidized bed, into the fluidized bed itself, or both. The location of the introduction of the reagent(s) may be dependent on the particular reagent. In one example, at least one reagent is introduced directly into the fluidized bed. In some embodiments, this may be the last reagent added. In other embodiments, at least one reagent may be introduced into the water before the water enters the fluidized bed. This introduction of a reagent may be referred to as chemical dosing.

Examples of reagents which may be used include, without limitation, NaHCO₃, NaOH (aqueous solutions of about 5% to about 50%, particularly about 25% to about 50%), lime (CaO), hydrated lime (Ca(OH)₂), CaCl₂, and combinations thereof. If the target element concentration of water is high, the water may be doped with additional amounts of the principal ion(s).

Reagent dosing rates may depend on reagent concentrations, volume of water treated, and required removal rate. For maximum removal, a small excess above the required stoichiometric amount of added reagent (about 5% to about 10%) will be required. However, due to cost and product water quality considerations, maximized removal may not be preferred. This is best evaluated on a case-by-case basis to determine the most advantageous reagent dosing levels.

Because of the accretion of the crystalline principal ion(s) and/or target element(s) on the grains of the fluidized bed these grains increase in size and weight, and the weight of the bed increases. This causes the minimum fluidization velocity to rise. If this minimum fluidization velocity reaches the value of the current velocity used, the fluidized bed ceases to be fluidized. In order to prevent this occurrence, the largest particles may be periodically removed from below in the reactor. In order to keep the number of particles more or less constant in the reactor, fresh seed particles may be added in the upper region of the reactor.

The pellets produced may contain about 70 wt % to about 95 wt % of the principal ion(s) incorporated in the crystallized lattice which may also contain incorporated at least one target element. About 5 wt % to about 30 wt % of the pellets may be seed material, moisture, and trace materials that may become incorporated in the pellet. In some cases, the crystallized lattice may be about 95% to about 100% of the principal ion(s) incorporated in the crystallized lattice when principal ion carbonate is utilized as the engineered seed.

Target element concentrations that may be present in the crystallized lattice of the pellet may be controlled to allow utilization of pellets within any regulatory limits or application standards. Target element levels in the pellets are dependent on the target element concentrations of the influent or raw water, the seed material, principal ion, chemical reagents, and the relative proportions of these materials that are incorporated into the pellets. In preferred applications, the primary source of the target element(s) will be the influent water. To the extent that seed material and other chemical reagents are incorporated into the pellets, these materials behave as diluents of the target element(s) from the raw water. Application of Formula 7, below, may allow prediction and control of the level(s) of the target element(s) of the pellets.

Derivation of Formula 7, below, starts with the following expression for any target element contained in the pellets:

Aₚ=f_{w}A_{w}+fₛAₛ+f_{c}A_{c} (1)
where Aₚ is some measure of the concentration of target element cation A in the pellets. This concentration may be expressed as, but is not limited to, a gravimetric concentration (i.e., mg A/kg pellet), or, in the case of radioactive cations, the concentration may be expressed as the radioactivity of the pellets (i.e., pCi/g or Bq/kg). The fraction of the pellet weight, fₓ, is from constituent x, and Aₓ is the concentration of cation A in constituent x. Two constituents, influent water, w, and seed material, s, will always contribute to the material in the pellets; additional constituents, from chemical reagents, c, may or may not be present in the pellets. For example, addition of hydrated lime (also known as calcium hydroxide) to the pellet reactor will result in some fraction of the pellet being the result of crystallization of calcium from the lime into the pellet as calcium carbonate. Similarly, magnesium hydroxide could be added to the pellet reactor resulting in some fraction of the pellet being the result of crystallization of magnesium from the magnesium hydroxide into the pellet as magnesium carbonate. Target element concentrations in the seed material and chemical reagents can be measured empirically and expressed in the appropriate units; if Aₛ and/or A_{c} are small compared with A_{w}, those terms in formula 1 can be ignored and the concentration of target element cation A in the pellets is

Aₚ=f_{w}A_{w} (2)
Therefore, the weight fraction from influent water to produce pellets with a desired target element concentration of Aₚ is

f_{w}=Aₚ/A_{w}. (3)
The remaining mass in the pellets must come from seed material and chemical reagents if any.
The concentration of target element cation A in the water may be expressed as the ratio of concentration of A (B_{A}) to the concentration of the principal ion(s) crystallized. In the case where calcium and/or magnesium are the principal ions in crystallization (C_{Ca/Mg} in mg (Ca/Mg)CO₃/L), the concentration of target element cation A can be found by taking the ratio of volumetric concentration each times their respective incorporation factor, i_{y}, as shown in formula 4.

$${A}_{w} = \frac{{i}_{A} {B}_{A}}{{i}_{Ca \text{/} Mg} {C}_{Ca \text{/} Mg}} \qquad ( 4 )$$

For a first approximation i_{A} and i_{Ca/Mg} can be assumed to be equal and substitution of formula 4 into formula 3 gives:

$${f}_{w} = \frac{{A}_{p} {C}_{Ca \text{/} Mg}}{{B}_{A}} \qquad ( 5 )$$

The units of f_{w} in formula 5 will be mg (Ca/Mg)CO₃/g pellet. The weights of all constituents must sum to one, so

1=f_{w}+fₛ+f_{c} (6)
substitution of formula 5 into formula 6 and rearranging, gives

$${f}_{s} + {f}_{c} = 1 - \frac{{A}_{p} {C}_{Ca \text{/} Mg}}{{B}_{A}} \qquad ( 7 )$$

Thus, by knowing desired target element concentration Aₚ and the target element concentration of the water, the fraction of the pellet weight that may come from the seed material and the chemical reagents may be determined by using Formula 7. These fractions fₛ and f_{c} are independent and may be adjusted, in part, based on the type of water being treated. Each may be anywhere from 0 to 1. In some embodiments, fₛ is greater than f_{c}. In some embodiments, f_{c} may be zero. The cost of producing and transporting seed material versus providing chemical constituents to incorporate into pellets may be a factor in determining the best approach. This may be evaluated on a case-by-case basis to determine the most advantageous method to dilute a target element cation A in the pellets.

In some independent aspects and in some constructions, two or more fluidized beds may be used in series, in which the injection of the reagent occurs at or before the entrance of the fluidized bed. This arrangement may allow improved softening and/or target element removal from influent water.

In some independent aspects and in some constructions, the present methods may result in a principal ion reduction of at least about 80%, particularly about 85%, and suitably about 90%. In some independent aspects and in some constructions, the present methods may result in a target element reduction of at least about 40%, particularly of about 60%, and suitably of about 95%. Without being limited by any particular theory, it is believed that the overall efficiency in some embodiments may be increased with higher influent principal ion and/or target element concentrations. However, to achieve the same ultimate effluent concentration of principal ion(s) and/or of target element(s), adjusting the capacity, chemical dosing or other protocols, such as recycling part of the influent or effluent, may be necessary.

The ranges and parameters described above may change depending on the location of the water to be treated. For example, different water sources, such as those listed above, requiring removal of different target elements may have different requirements. The proper adjustment of these parameters to location can be made by one skilled in the art.

The amount of pellets produced by the method(s) of the present application may be dependent on the amount of water that is treated and the concentration of any target and/or principal ions in the water.

The pellets may contain safe levels of the target element(s) and, therefore, may be used in industry. For instance, without limitation, the pellets may contain non-hazardous levels of radioactive cations. Examples of uses may include, but are not limited to using the pellets as a re-usable resource, such as aggregate material. Specific examples include, without limitation, aggregate bedding material, concrete filler material, or other existing aggregate and limestone uses. Other examples include, without limitation, use of the pellets in concrete aggregate, backfill base, bituminous course, bituminous surface, asphalt, and combinations thereof. Further examples include using the pellets in concrete products, in roads, as filler, for snow and ice control, as roofing granules, and for other miscellaneous uses. The pellets may replace and save quickly depleting natural aggregates. Another example of pellet use may be as a fertilizer, depending on the contents of the pellets.

Without being limited by theory, it is believed that the pellets may, when applied as a partial replacement of concrete aggregates, improve the properties of Portland cement concrete in a fresh state. Portland cement concrete is just one concrete type with standard cement content of about 300 kg/m³. The pellets may be used to replace the commercial grade fine quartz sand in concrete. The pellets may improve the flowability and/or the strength of concrete. The pellets may also improve the workability of concrete and/or allow for the design of self-consolidating concrete.

Different utilization levels with respect to the quantities of pellets used as aggregate filler may be used. For instance, depending on the particle size range and the characteristics of the pellets, pellets can replace up to 100% of natural virgin aggregates. These utilization levels may be dependent on regulations for the use of certain target elements in construction materials. If using pellets with radioactive cations, these utilization levels will be dependent on regulations for maximal radioactivity levels for construction materials.

In some independent aspects and in some constructions, pellets with radioactive levels of less than 2,000 Bq/kg (54 pCi/g), particularly less than 1,000 Bq/kg (27 pCi/g), and more particularly less than 250 Bq/kg (7 pCi/g) may be used in concrete. The activity level of the pellets and the use (actual application) will ultimately determine the extent to which the pellets may be incorporated. The United States does not currently have standards for activity levels of material used in construction. The United States National Regulatory Commission (NRC) has set regulations specific to packaging and transportation of radioactive material (10 CFR, Part 71-Packaging and Transportation of Radioactive Material, Appendix Table A-2). The regulation set by the NRC for packaging and transportation of radium 226 and radium 228 is 270 pCi/g.

Since the United States does not have regulatory documents related to radioactivity of building materials, a radioactivity assessment can be performed using conservative European Norms: “Radiation Protection 112: Radiological Protection Principles concerning the Natural Radioactivity of Building Materials” or Guide St 12.2-2003, “The Radioactivity of Building Materials and Ash”. These international documents distinguish between “safe” and “unsafe” products. St 12.2-2003 regulates the use of building materials originating from rock, soil and/or industrial by-products that contain natural radionuclides, including uranium (²³⁸U) and thorium (²³²Th) and their decay products, and the radioactive isotope of potassium (⁴⁰K). This regulatory document presents the limiting levels related to gamma radiation exposure caused by building materials and materials used in road, street, and related building, landfill and/or landscaping materials. The document also presents the levels for handling and disposing of fly ash.

Activity indexes may be used to assess whether or not an action level exceeds acceptable levels of radioactivity. In Europe, activity indexes (I) or action levels have been defined to limit the radiation exposure due to building materials (STUK Guide 12.2, Oct. 8, 2003). The activity indexes are calculated from activity concentration measurements of the material and on the basis of the activity concentrations (in Bq/kg) of radium 226 (C_{Ra}) in the uranium decay series, thorium 232 (C_{Th}) in the thorium decay series, potassium 40 (Cₖ) and cesium 137 (C_{Cs}) from fallout (if present). Different activity indexes have been defined particular to the practice or use of the material. If the activity index exceeds 1, the responsible party is required to show specifically that the relevant action level has not been exceeded. For each practice or use, the calculated activity index I for the material must be equal to or less than the value of 1 in order to be able to use the material without restriction (as far as radioactivity is concerned). St 12.2-2003 sets four activity indexes. For final building materials used in the building of a house, the following activity index is used:

$${I}_{1} = \frac{{C}_{Th}}{200} + \frac{{C}_{Ra}}{300} + \frac{{C}_{K}}{3000}$$

where C_{Th}, C_{Ra}, and C_{K} are the activity concentrations of ²³²Th, ²²⁶Ra, and ⁴⁰K in the final product, expressed in Bq/kg. The activity index I₁ is also applied for the filling materials used under and near the building. If the activity index I₁ is 1 or less than 1, the material can be used as building material, so far as the radioactivity is concerned, without restriction. In the case of superficial or other materials with a restricted use in house building (for example, thin wall or floor tiles, the activity index I₁ must be 6 or less than 6.

For materials used in road, street and related building or construction work, the following activity index is used:

$${I}_{2} = \frac{{C}_{Th}}{500} + \frac{{C}_{Ra}}{700} + \frac{{C}_{K}}{8000} + \frac{{C}_{cs}}{2000}$$

where C_{Th}, C_{Ra}, C_{K}, and C_{Cs} are the activity concentrations of ²³²Th, ²²⁶Ra, ⁴⁰K, and ¹³⁷Cs in the final product, expressed in Bq/kg. If the activity index I₂ is 1 or less than 1, the material can be used, as far as the radioactivity is concerned, without restriction. In the case of materials with a restricted use (for example, usual paving stones and flags), the activity index I₂ must be 1.5 or less than 1.5.

For materials used in landfill and landscaping, the following activity index is used:

$${I}_{3} = \frac{{C}_{Th}}{1500} + \frac{{C}_{Ra}}{2000} + \frac{{C}_{K}}{20000} + \frac{{C}_{cs}}{5000}$$

where C_{Th}, C_{Ra}, C_{K} and C_{Cs} are the activity concentrations of ²³²Th, ²²⁶Ra, ⁴⁰K and ¹³⁷Cs in the final product, expressed in Bq/kg. If the activity index I₃ is 1 or less than 1, the material can be used, as far as the radioactivity is concerned, without restriction. If the activity index I₃ exceeds 1, the responsible party is required to investigate the disposal of the material.

For handling of ash the following activity index is used:

$${I}_{4} = \frac{{C}_{Th}}{3000} + \frac{{C}_{Ra}}{4000} + \frac{{C}_{K}}{50000} + \frac{{C}_{cs}}{10000}$$

where C_{Th}, C_{Ra}, C_{K} and C_{Cs} are the activity concentrations of ²³²Th, ²²⁶Ra, ⁴⁰K, and ¹³⁷Cs in the final product, expressed in Bq/kg. If the activity index I₄ is 1 or less than 1, as far as the radioactivity is concerned, no restrictions are required for handling the ash. If the activity index I₄ exceeds 1, the responsible party is required to provide extra protection for workers who handle ash, as stated in Guide ST 12.1.

In some independent aspects and in some constructions, methods of the present application may eliminate radioactive or radium-containing waste and wastewater otherwise produced by prior art technologies.

In some independent aspects and in some constructions, methods of the present application may provide safe higher quality water that meets EPA safe drinking water standards and provides value to the public as softened water. The current EPA safe drinking water standard for radium is that the combined activity from Ra-226 and Ra-228 must be less than 5 pCi/L.

In some independent aspects and in some constructions, methods of the present application may reduce or eliminate chlorides from water. The method of the present application may replace ion exchange based resin softening at the municipal level or in individual residences. Resin softening results in chloride discharge that may represent 50%-90% of the chloride found in wastewater. The methods of the present application may remove at least one principal ion without the use of chlorides, thus mitigating municipal water plant non-compliance and the associated cost of meeting the American Water Quality Standards.

In some independent aspects and in some constructions, methods of the present application may produce principal ion carbonate and/or principal ion carbonate containing at least one target element pellets that may be used by the agricultural and construction industries. In one embodiment, this may offset the raw material and environmental cost of mining and transporting limestone from conventional limestone mines.

In some independent aspects and in some constructions, methods of the present application may extract at least one target element from water and secure the target element(s) against exposure to the environment (soil and water) and potential exposure risk to the public. In the case of radium, one exposure risk, without limitation, may be through ingestion.

In some independent aspects and in some constructions, methods of the present application may increase water supply availability by up to about 10% to about 20% by removing wastewater and sludge produced by prior art technologies. As mentioned above, conventional prior art softening and target element treatments may waste about 10%-20% of the supply water, which is discharged as concentrated wastewater, deep-well injected, or treated again for surface discharge. Additionally, by using the method(s) of the present application, aquifers and water supplies that are normally avoided due to cost and the waste(s) associated with target element treatment may be used.

In some independent aspects and in some constructions, methods of the present application may reduce public operating costs while providing better quality supply water to the public and eliminating waste.

In some independent aspects and in some constructions, the pellet reactor of the present application may provide the following advantages over other systems/processes: 1) smaller size; 2) shorter reaction time (up to about 16 times less); 3) clean, no waste-production; 4) easy to handle crystal grains; and 5) possibility for recycling pellets.

### EXAMPLES

Exemplary embodiments of the present application are provided in the following examples. The following examples are presented to illustrate the present invention and to assist one of ordinary skill in making and using the same. The examples are not intended in any way to otherwise limit the scope of the invention.

### Example 1

### Dual Treatment Optimization

A fluidized bed reactor shown in FIG. 2 was used as part of a pilot unit shown in FIG. 1. The pilot unit as shown in FIG. 1 was installed at the Wisconsin Waukesha Water Utility (WWU), Well #8 location. The pilot unit was connected to the power source and to a deep well water supply. The pilot unit was used to treat raw well water with the radium and hardness contents shown in Table 1 below. The diameter of the pilot unit was 12″ ID.

TABLE 1
Hardness and Radioactivity of Water from Well #8.

| | | | Combined Ra | Hardness |
|---|---|---|---|---|
| | Gross α | Gross β | (Ra-226 & | (CaCO₃; |
| Sample Date: | (pCi/L) | (pCi/L) | Ra-228) (pCi/L) | mg/L) |
| Oct. 12^{th} 2006 | 21.0 ± 3 | 15.0 ± 1 | 8.7 ± 0.8 | 299 |
| Jun. 18^{th}, 2008 | 15.7 ± 2.5 | 15.0 ± 1.3 | 7.2 ± 1.0 | 320 |
| Jun. 26^{th}, 2008 | 23.0 ± 4.0 | 17 ± 1.0 | 9.6 ± 0.7 | 288 |
| Jul. 21^{st}, 2008 | 33.0 ± 8.0 | 20 ± 9.0 | 9.4 ± 0.6 | 330 |

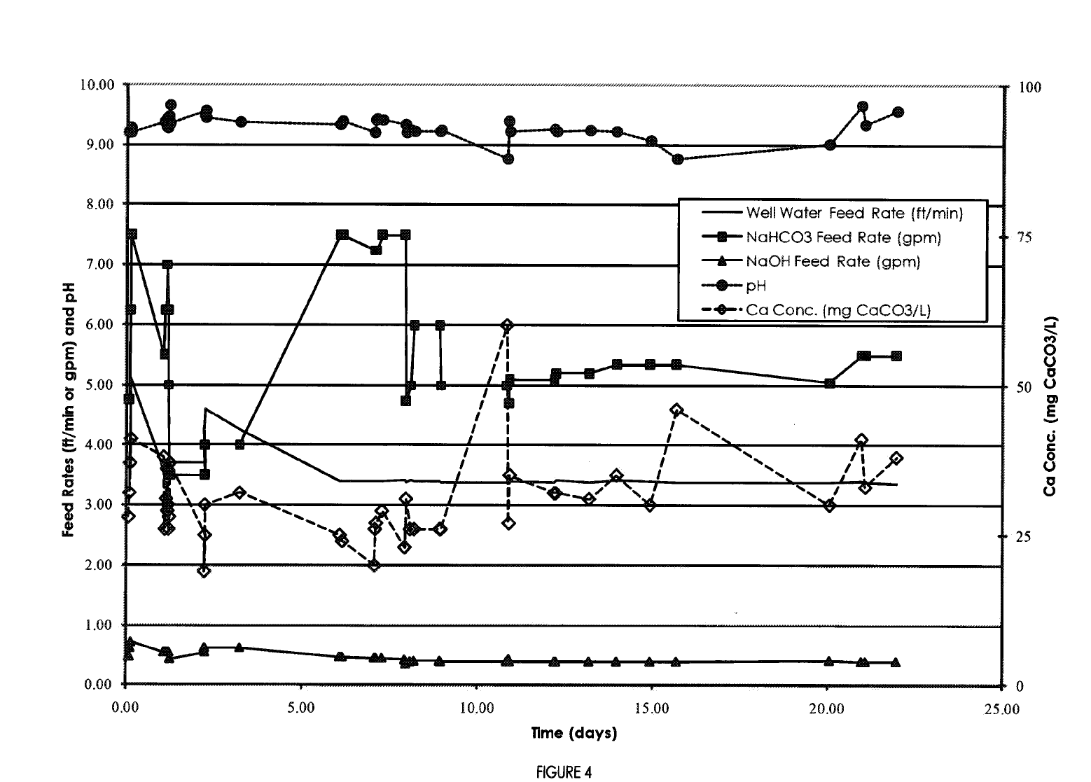

The pilot unit was operated at various feed rates (2 ft/min, 5 ft/min, 3.5 ft/min), to determine advantageous conditions for performing an extended testing of softening and radium removal. Operating parameters were selected to be feed rate ˜3.5 ft/min, chemical dosing rate of the first reagent, 4.6% sodium bicarbonate (NaHCO₃), of ˜5-7 gph, chemical dosing rate of the second reagent, 25% sodium hydroxide (NaOH), of ˜0.4-0.7 gph so that pH was controlled at about 9 to 9.5. Effluent water samples from the pellet reactor were tested for calcium hardness at the pilot site with HACH titration kits. These operating parameters are summarized in FIG. 4 for the ˜22 day duration of this example. The average calcium hardness of the effluent during this period was 31.05 mg CaCO₃/L which is about a 90% reduction of the calcium hardness in the influent water.

Two sets of water samples, both influent and effluent, were collected for radium measurement on day 1, Jun. 18, 2008, and on day 9, Jun. 26, 2008, the samples were transported to the Wisconsin State Laboratory of Hygiene (WSLH) for analysis. WSLH, Environmental and Health Division, is a certified radiochemistry laboratory (ID: E37658 (NELAC), ID: 113133790 (DNR)). The results from these samples are shown in Table 2 below. Under the conditions summarized in FIG. 4, the radium concentrations were reduced by approximately 90% to levels well below the EPA combined limit of 5 pCi/L.

TABLE 2
Radium Isotope 226 and 228 Test Results.

| | Radium 226 | | | Radium 228 pCi/L | | |
|---|---|---|---|---|---|---|
| Sample | Influent | Effluent | Reduction | Influent | Effluent | Reduction |
| Date | (pCi/L) | (pCi/L) | (%) | (pCi/L) | (pCi/L) | (%) |
| Jun. 18^{th}, | 2.4 | 0.28 | 88 | 4.8 | 0.5 | 90 |
| 2008 | | | | | | |
| Jun. 26^{th}, | 3.0 | 0.35 | 88 | 6.6 | 0.47 | 93 |
| 2008 | | | | | | |

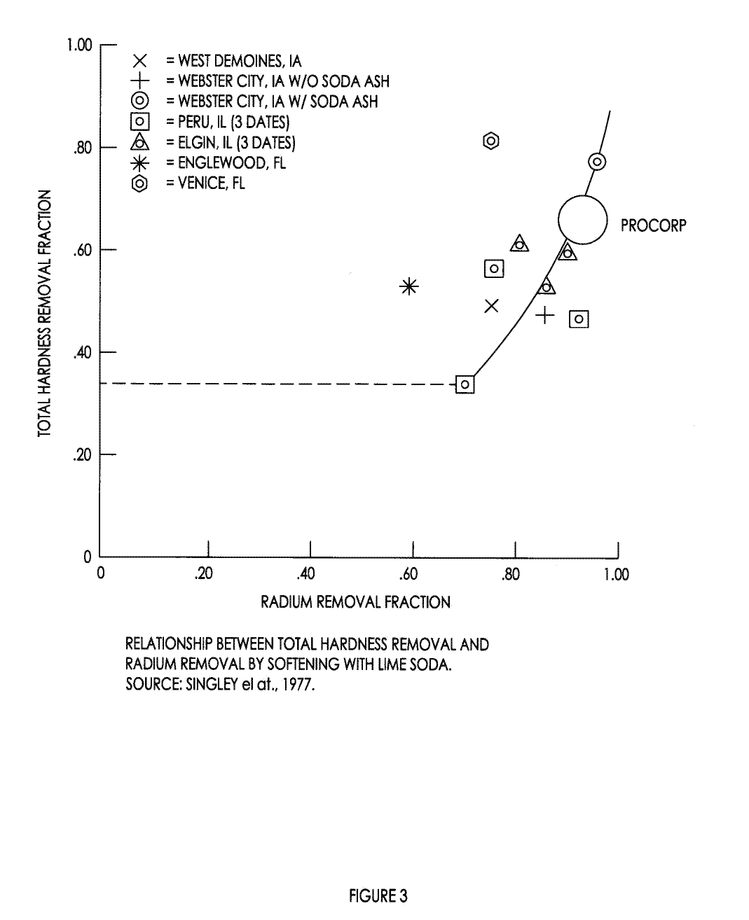

These test results, as compared to the prior art, are shown in FIG. 3. There is one data point for the prior art that achieved slightly better results than these test results. However, that process used soda ash, which is costly. This example did not use soda ash. The method(s) of the present application may or may not use soda ash.

### Example 2

### Sodium Hydroxide Treatment

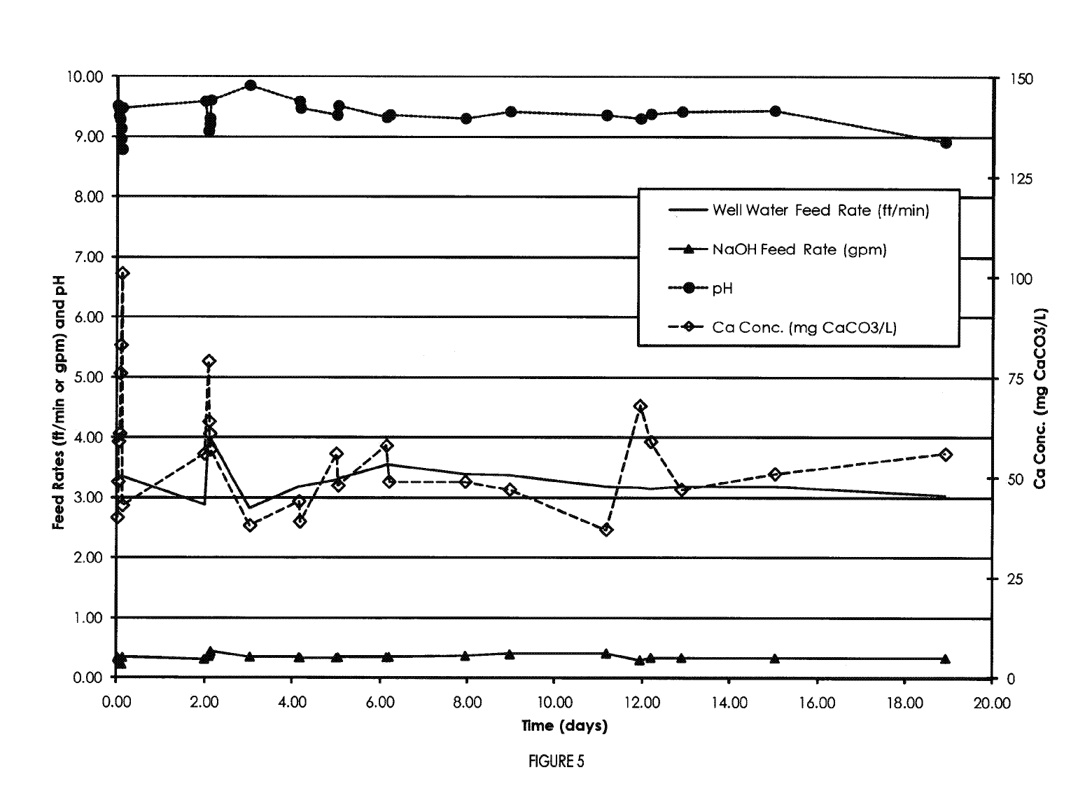

After completion of the testing period for Example 1 above, the chemical dosing rate of the first reagent, sodium bicarbonate was terminated and a new trial lasting ˜19 days using only chemical dosing of 25% sodium hydroxide, (NaOH), of ˜0.25-0.45 gph, was started. Effluent water samples from the pellet reactor were tested for calcium hardness at the pilot site with HACH titration kits. These operating parameters are summarized in FIG. 5 for this example. The average calcium hardness of the effluent during this period was 56.25 mg CaCO₃/L, which is about an 82% reduction of the calcium hardness in the influent water.

One set of water samples, both influent and effluent, were collected for radium measurement on day 12, Jul. 21, 2008, the samples were transported to WSLH for analysis. The results from these samples are shown in Table 3 below. Under the conditions summarized in FIG. 5, the radium concentrations were reduced by approximately 60% to levels below the EPA combined limit of 5 pCi/L.

TABLE 3
Radium Isotope 226 and 228 Test Results.

| | Radium 226 | | | Radium 228 pCi/L | | |
|---|---|---|---|---|---|---|
| Sample | Influent | Effluent | Reduction | Influent | Effluent | Reduction |
| Date | (pCi/L) | (pCi/L) | (%) | (pCi/L) | (pCi/L) | (%) |
| Jul. 21^{st}, | 2.7 | 1.2 | 56 | 6.7 | 2.3 | 66 |
| 2008 | | | | | | |

### Example 3

### Secondary Ion Removal

The treatment method outlined in Example 2 also reduced manganese (from 0.1 to 0.04 ppm) and iron (from 0.28 to 0.05 ppm). These secondary ions were also removed as part of the incorporation process of additional cations present in the feed water into the calcium carbonate crystalline lattice.

### Example 4

### Byproduct Pellet Testing

Though treatment chemistries throughout the pilot study varied, the incorporation mechanism of radium isotopes into the calcium carbonate crystalline lattice within the column of the pellet reactor remained the same. The frequency or uptake of radium isotopes into the calcium carbonate crystalline lattice, however, may have varied. Actual uptake of radium isotopes will determine the radioactivity of the pellets produced in the reactor. Byproduct utilization of the pellets produced will be highly dependent on the radioactivity present. Because of this, a byproduct pellet sample was discharged from the reactor and collected on Aug. 19, 2008. The pellet sample was taken to the WSLH for analysis. A gamma spectroscopy analysis was performed on the pellet sample for two sample states. The first state analyzed was the unaltered pellet samples as discharged directly from the reactor. The second state analyzed was the radioactivity associated with the pellet samples when the pellet was crushed. The radioactivity associated with the pellet samples is displayed in Table 4 below:

TABLE 4
Gamma Spectroscopy analysis for pellet sample
collected on Aug. 19^{th}, 2008.

| | Nuclide Result (pCi/g) | | | | |
|---|---|---|---|---|---|
| State | Ra-226 | Ac-228^{a} | K-40 | Cs-137 | Pb-214 |
| Crushed | 12.9 ± 0.6 | 25.3 ± 0.7 | <0.57 | <0.06 | 12.7 ± 0.4 |
| Uncrushed | 12.5 ± 0.6 | 24.9 ± 0.7 | <0.87 | <0.08 | 12.2 ± 0.3 |

^{a}Ac-228 in this table correlates with the activity of Ra-228 removed from the source water.

The activity level calculations (European standards) for the pellet samples were then applied to obtain a preliminary understanding of the potential radiation exposure if used in building materials. It is important to note that the concentration of thorium 232 was not a result that was obtained from the WSLH from the Gamma Spectroscopy analysis of the pellet samples. Therefore, the actinium 228 (a daughter product in the Th-232 decay series) concentrations reported were substituted in place of the Th-232 within the calculated indexes. It is also important to note that where concentrations reported from the WSLH were reported as “less than” (<) a certain level, the threshold concentration that it falls under was used. These assumptions were made to obtain the most conservative activity index possible. It is believed that the actual concentration of Th-232 in the pellets would be lower than the concentration of Ac-228 that was used. Table 5 below is a summary of the activity indexes with respect to potential use in construction.

TABLE 5
Calculated action levels for the pellet samples with respect to
restrictions associated with potential use in construction materials.

| | Action Level or | | |
|---|---|---|---|
| | Activity Index Result | | Within |
| | Crushed | Uncrushed | Restriction |
| Index | (Bq/kg) | (Bq/kg) | Limit |
| Materials used in house; I₁ | 6.28 | 6.16 | NO |
| Materials used in street/road; I₂ | 2.56 | 2.51 | NO |
| Materials used in Landscaping; I₃ | 0.86 | 0.85 | YES |
| Materials used in handling ash; I₄ | 0.43 | 0.42 | YES |

Under European standards and with the assumptions stated above, the radioactivity associated with the pellets samples would be within restriction limits and would be able to be safely used as materials in landfill, landscaping and handling of ash. The calculated action levels of the pellets for use as materials in street or road construction is just slightly above the threshold. However, the restriction limits set by the European standards are for by-products or wastes in building materials used as 100% of the material. The pellets may be used as building materials used in street and road construction as a smaller percentage of incorporation or with a sufficient layer of material (cover) that absorbs gamma radiation. In this case, the restricted use may still be acceptable.

It is asserted that, by removing pellets sooner and/or by using larger seed material, pellets with action levels considered acceptable at least for use in Europe for street or road construction would be produced.

### Example 6

### Removal of Nickel and Zinc from Cooling Tower Water

Using the method(s) of the present application the principal ions, magnesium and calcium were removed from water in a cooling tower using a laboratory scale pellet reactor. Target elements, nickel and zinc, were removed as well. Therefore, the water in the cooling tower may be re-used at a higher rate without the nickel and zinc concentrations increasing to unacceptable levels.

Total hardness in the cooling tower water was measured to be 2310 as ppm CaCO3; however most of this was MgCO3, ˜1990 ppm. The concentrations of trace metals Zn and Ni were measured to be 140 and 13 ppb respectively.

To soften water with this level of hardness without overloading, the reactor was operated with various levels of recirculation (see below). Sodium bicarbonate was fed to provide a ˜6× stoichiometric excess of carbonate for crystallization and NaOH was used to control reactor pH at between 9.6 and 9.8. Treatment times were sufficient to ensure the reactor system was in steady state before samples were collected for trace metal analysis. Table 6 below is a summary of reactor effluent quality demonstrating removal of the target elements zinc and nickel.

TABLE 6
Reactor Effluent Quality.

| ADM | | | | | | | |
|---|---|---|---|---|---|---|---|
| Water | | | | | | | |
| as | Reactor Effluent | | | | | | |
| % of | | Total | | | | | |
| Reactor | | Hard- | % | [Zn] | % | [Ni] | % |
| Flow | pH | ness | Removal | ppb | Removal | ppb | Removal |
| 10% | 9.67 | 400 | 83% | 30 | 79% | 4 | 69% |
| 20% | 9.80 | 490 | 79% | 20 | 85% | 1 | 92% |

### Example 7

A fluidized bed reactor shown in FIG. 2 was used as part of a pilot unit shown in FIG. 1. The pilot unit as shown in FIG. 1 was installed at a natural gas well site in West Virginia. The pilot unit was connected to a power source and to tanks containing wastewater from the drilling and fracturing of natural gas wells. The diameter of the pilot unit was 18″ ID.

The pilot unit was operated at a wastewater feed rate of 4 gpm and a recirculation rate of 52 gpm. Sodium carbonate was the only chemical reagent used. The sodium carbonate was fed at an 8.9 wt % solution with an approximate usage of 100 dry pounds per 1000 gallons of wastewater fed to the reactor. Influent and effluent samples to and from the pellet reactor taken and results are shown in Tables 7 to 12. The target compound removal (Calcium) was 99.5%. The non-target removal was 100% for barium and 99.4% for strontium.

TABLE 7
Pellet Reactor Influent Water Results.

| Tested For | Result |
|---|---|
| Density (g/mL @ 25° C.) | 1.03951 |
| pH (at Lab) | 7.10 |

TABLE 8
Pellet Reactor Influent Water Results - Cations.

| Tested For | Results (mg/L) |
|---|---|
| Calcium | 4,690 |
| Sodium | 17,600 |
| Magnesium | 509.6 |
| Potassium | 685.4 |
| Manganese | 1.9 |
| Iron | 0.1 |
| Strontium | 1,283 |
| Barium | 47.2 |
| Boron | 44.7 |

TABLE 9
Pellet Reactor Influent Water Results - Anions.

| Tested For | Results (mg/L) |
|---|---|
| Chloride | 36,856 |
| Sulfate | 85.9 |
| Bromide | 365.6 |
| Phosphate | 0.0 |
| Bicarbonate | 48.8 |
| Carbonate | 0.0 |
| Hydroxide | 0.0 |

TABLE 10
Pellet Reactor Effluent Water Results.

| Tested For | Result |
|---|---|
| Density (g/mL @ 25° C.) | 1.04466 |
| pH (at Lab) | 8.67 |

TABLE 11
Pellet Reactor Effluent Water Results - Cations.

| Tested For | Results (mg/L) |
|---|---|
| Calcium | 33.7 |
| Sodium | 29,110 |
| Magnesium | 420.1 |
| Potassium | 768.4 |
| Manganese | 0.9 |
| Iron | 0.1 |
| Strontium | 8.1 |
| Barium | 0.0 |
| Boron | 40.1 |

TABLE 12
Pellet Reactor Effluent Water Results - Anions.

| Tested For | Results (mg/L) |
|---|---|
| Chloride | 44,195 |
| Sulfate | 0.0 |
| Bromide | 494.9 |
| Phosphate | 0.0 |
| Bicarbonate | 97.6 |
| Carbonate | 240.0 |
| Hydroxide | 0.0 |

### Example 8

A fluidized bed reactor shown in FIG. 2 was used as part of a pilot unit shown in FIG. 1. The pilot unit as shown in FIG. 1 was installed at a natural gas well site in West Virginia. The pilot unit was connected to a power source and to tanks containing wastewater from the drilling and fracturing of natural gas wells. The diameter of the pilot unit was 18″ ID.

The pilot unit was operated at a wastewater feed rate of 4 gpm and a recirculation rate of 52 gpm. Sodium carbonate was the only chemical reagent used. The sodium carbonate was fed at an 8.9 wt % solution with an approximate usage of 250 dry pounds per 1000 gallons of wastewater fed to the reactor. Influent and effluent samples to and from the pellet reactor taken and results are shown in Tables 13 to 18. The target compound removal (Calcium) was 85.6%. The non-target removal was 90.5% for barium and 81.9% for strontium.

TABLE 13
Pellet Reactor Influent Water Results.

| Tested For | Result |
|---|---|
| Density (g/mL @ 25° C.) | 1.08343 |
| pH (at Lab) | 7.37 |

TABLE 14
Pellet Reactor Influent Water Results - Cations.

| Tested For | Results (mg/L) |
|---|---|
| Calcium | 11,670 |
| Sodium | 33,880 |
| Magnesium | 1,255 |
| Potassium | 1,534 |
| Manganese | 1.1 |
| Iron | 0.1 |
| Strontium | 2,888 |
| Barium | 102.0 |
| Boron | 90.5 |

TABLE 15
Pellet Reactor Influent Water Results - Anions.

| Tested For | Results (mg/L) |
|---|---|
| Chloride | 84,067 |
| Sulfate | 0.0 |
| Bromide | 892.4 |
| Phosphate | 0.0 |
| Bicarbonate | 122.0 |
| Carbonate | 0.0 |
| Hydroxide | 0.0 |

TABLE 16
Pellet Reactor Effluent Water Results.

| Tested For | Result |
|---|---|
| Density (g/mL @ 25° C.) | 1.04124 |
| pH (at Lab) | 7.39 |

TABLE 17
Pellet Reactor Effluent Water Results - Cations.

| Tested For | Results (mg/L) |
|---|---|
| Calcium | 1,657 |
| Sodium | 22,390 |
| Magnesium | 501.1 |
| Potassium | 757.6 |
| Manganese | 0.6 |
| Iron | 0.7 |
| Strontium | 516.6 |
| Barium | 9.7 |
| Boron | 38.5 |

TABLE 18
Pellet Reactor Effluent Water Results - Anions.

| Tested For | Results (mg/L) |
|---|---|
| Chloride | 45,070 |
| Sulfate | 0.0 |
| Bromide | 509.5 |
| Phosphate | 0.0 |
| Bicarbonate | 73.2 |
| Carbonate | 0.0 |
| Hydroxide | 0.0 |

### Example 9

A self-consolidating concrete (“SCC”) was prepared as follows.

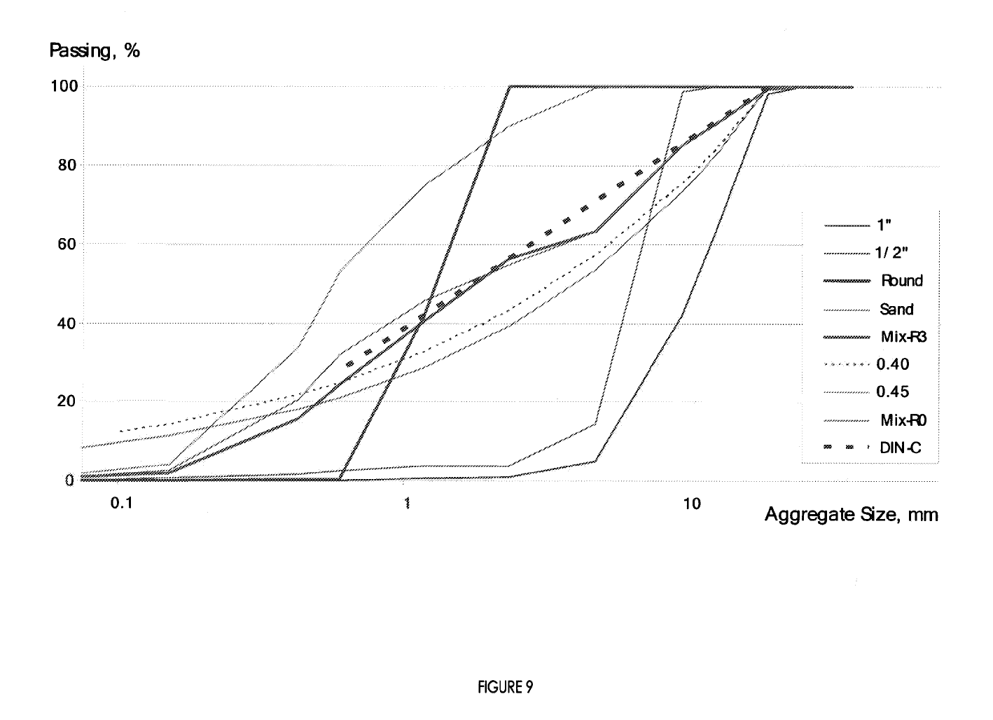

The design of SCC may require the adjustment of the aggregate's proportions. While regular concrete is commonly optimized for 0.45 power curve (FIG. 9), the optimal aggregate proportions for SCC may require a “finer” mixture, reaching the limit “C” as specified by DIN (Deutsches Institut für Normung). FIG. 9 shows the aggregate's mix optimization to produce SCC. The application of round, mid-size and sand-size aggregates can help to enhance the flow and pumping properties of concrete and, especially, of SCC.

In this example, synthetic calcium carbonate pellets (“SCCP”) of the present application that were spherical, sand-sized particles, were effectively used as fine aggregates in SCC. The spherical shape of SCCP may be a property that may improve the properties of Portland cement concrete in a fresh state. The SCCP were manufactured as a co-product of water purification technology using a pellet reactor softening process, such as that described above.

### Materials

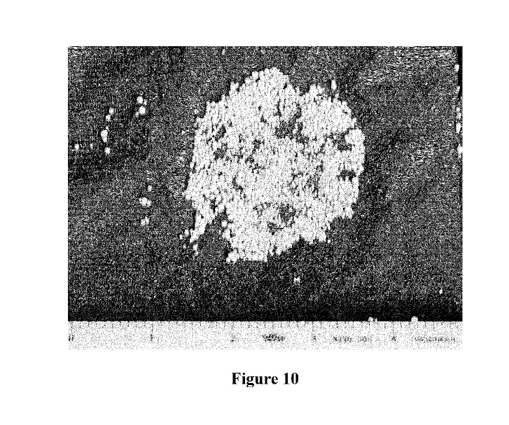

The following materials were used. Cementitious materials included ASTM Type I Portland cement with a specific gravity of 3.15 and a Blaine fineness of 380 m²/kg. 25 mm (1″) maximum size crushed granite, 12.5 mm (½″) crushed limestone and local (Milwaukee, Wis.) natural sand were used as coarse, mid-size and fine aggregates, respectively. Table 19 presents the grading of aggregates. The coarse, mid-size and fine aggregates each had a specific gravity of 2.65 and water absorptions of 0.15%, 0.25% and 0.5%, respectively. SCCP are represented by spherical sand particles with a size of 0.6-2.3 mm and low water absorption of 0.1% (FIG. 10). FIG. 10 shows SCCP used as round sand. A polycarboxylate-based high-range water-reducing admixture (“HRWRA”) was used in all concrete mixtures. A novel nano-SiO₂ admixture was used as a viscosity-modifying admixture (“VMA”) in SCC. Nano-SiO₂ was used in a form of water suspension which had a total solid content of 50%.

TABLE 19
Particle size distribution of aggregates.

| | | Passing, % | | | | | | |
|---|---|---|---|---|---|---|---|---|
| | | | | Fine | | | | |
| Sieve Size | | Coarse | | Aggregate - | | | | |
| No./ | | Aggregate | | Sand | | SCC Mix | | Power |
| in | mm | 1″ | ½″ | Round | Natural | R0 | R3 | 0.45 |
| 1.5 | 37.5 | 100 | 100 | 100 | 100 | 100 | 100 | 100 |
| 1 | 25 | 100 | 100 | 100 | 100 | 100 | 100 | 100 |
| 0.75 | 19 | 98 | 100 | 100 | 100 | 100 | 100 | 100 |
| 0.50 | 12.5 | 63 | 100 | 100 | 100 | 91 | 91 | 83 |
| 0.38 | 9.5 | 42 | 99 | 100 | 100 | 85 | 85 | 73 |
| No. 4 | 4.75 | 5 | 14 | 100 | 100 | 63 | 63 | 54 |
| No. 8 | 2.36 | 1 | 4 | 100 | 90 | 55 | 56 | 39 |
| No. | 1.18 | 0 | 4 | 42 | 75 | 46 | 41 | 29 |
| 16 | | | | | | | | |
| No. | 0.6 | 0 | 3 | 0 | 53 | 32 | 24 | 21 |
| 30 | | | | | | | | |
| No. | 0.425 | 0 | 2 | 0 | 34 | 20 | 15 | 18 |
| 50 | | | | | | | | |
| No. | 0.15 | 0 | 1 | 0 | 4 | 2 | 2 | 11 |
| 100 | | | | | | | | |
| No. | 0.075 | 0 | 0 | 0 | 2 | 1 | 1 | 8 |
| 200 | | | | | | | | |

### Mixture Proportions

The proportions of the concrete mixtures are summarized in Table 20. A total of 3 concrete mixtures were tested. These included one reference cement mixture (R0) and two mixtures with 5% and 15% of SCCP round sand, R1 and R3, respectively. A preliminary investigation program was performed to optimize the composition of reference mix R0 in respect to: a) aggregates proportioning; b) dosage of superplasticizer, HRWRA; and c) dosage of nano-SiO₂.

The concrete mixtures were designed for a relatively low water-cementious material ratio (“w/c”) of 0.44 and, at a water content of 220 kg/m³ (370 lb/yd³), this resulted in a cement factor of 500 kg/m³ (841 lb/yd³). It can be observed that the replacement of natural sand with up to 15% SCCP allows improving the particle size distribution (grading) of aggregate's mix (FIG. 9). Normally, the application of at least three aggregate sources is sufficient to meet the requirements for optimal aggregate proportioning in the case of regular concrete or SCC. The observation can be made that a 25:15:60 coarse-mid-size-sand aggregates mix provides the particle size distribution between the DIN curve “C” and the 0.40 power curve as demonstrated in FIG. 9. However, even in the case of high-quality aggregates, the design of SCC concrete may require using large quantities of sand (more than 50% in the aggregates mix); this may result in excessive quantities of particles with a size of 0.5-1 mm and a deficiency of particles ranging from 1.25-4.75 mm (FIG. 9). In addition to particle shape, such deficiency provides an opportunity for SCCP application in SCC. This means that a four-aggregate mix with SCCP can demonstrate a better workability than that of a three-aggregate mix. In this particular example, up to 15% of the aggregate mix was SCCP substituted for natural sand.

TABLE 20
Mixture proportions for self-consolidating concrete.

| | Mixture proportions, kg/m³ (lb/yd³) | | | | | | | |
|---|---|---|---|---|---|---|---|---|
| | | | Coarse | | | | | |
| | | | Aggregate | | Sand | | | nano-SiO₂ |
| Mixture | Cement | Water | 1″ | ½″ | Round | Natural | HRWRA | (VMA) |
| R0 | 500 | 220 | 433 | 260 | — | 1038 | 2.25 | 10 |
| | (841) | (370) | (728) | (437) | | (1746) | (4) | (17) |
| R1 | 500 | 220 | 433 | 260 | 87 | 952 | 2.25 | 10 |
| | (841) | (370) | (728) | (437) | (146) | (1601) | (4) | (17) |
| R3 | 500 | 220 | 433 | 260 | 260 | 779 | 2.25 | 10 |
| | (841) | (370) | (728) | (437) | (437) | (1310) | (4) | (17) |

### Casting and Curing of Test Specimens

All of the concrete mixtures were mixed for 5 min in a laboratory drum mixer. Tests were conducted on fresh concrete mixtures to determine J-ring flow and bleeding. From each concrete mixture, ten 100×200 mm (4″×8″) cylinders were cast for the determination of compressive strength. The specimens were cast in one layer without vibration.

After casting, all the molded specimens were covered with plastic sheets, and left in the curing room for 24 h. They were then demolded and the cylinders were returned to the moist-curing room at 23±2° C. and 100% relative humidity until test age.

### Testing of Fresh Concrete

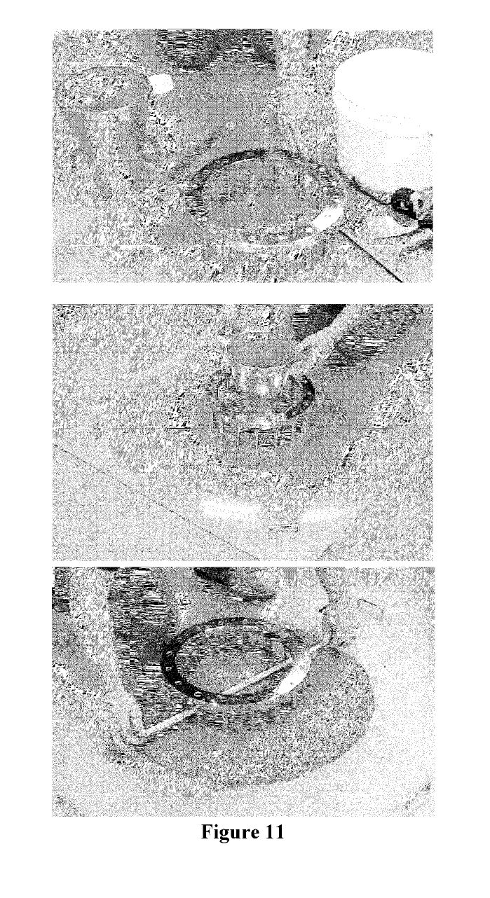

J-ring Test: When SCC is placed in forms containing steel reinforcement, the mixture should remain cohesive, and the aggregates should not separate from the paste fraction of the mixture when it flows between obstacles. This may be an important characteristic of the mixture when it is used in highly congested reinforced structures. The J-ring test is used to characterize the ability of SCC to pass through reinforcing steel. A sample of freshly mixed concrete is placed in an inverted standard slump cone installed concentrically with the J-ring (FIG. 11). FIG. 11 shows the J-ring test that was used to characterize the SCC.

The concrete is placed in one lift and is not consolidated by any means of mechanical or manual agitation. The slump is raised and the concrete is allowed to pass through the J-ring, which consists of a steel ring assembly containing reinforcing bars, and subside. The average of two diameters of the resulting spread, measured perpendicular to each other, is reported as the J-ring flow of the concrete.

The resulting slump flow is an indication of the passing ability of SCC through reinforcing steel. The higher the J-ring slump flow, the farther the SCC can travel through a reinforcing bar under its own mass from a given discharge point, and the faster it can fill a steel reinforced form or mold.

In addition to J-ring slump flow the slump and unit weight of the concrete mixtures were also measured.

### Testing of Mechanical Properties

For each concrete mixture, the compressive strength was determined on two cylinders at 1, 3, 7, 28 and 90 days. The mean value of the cylinder strengths at a particular age was considered as the compressive strength.

### Fresh Concrete Properties

The J-ring slump flow, slump and unit weight of the fresh concretes are presented in Table 21.

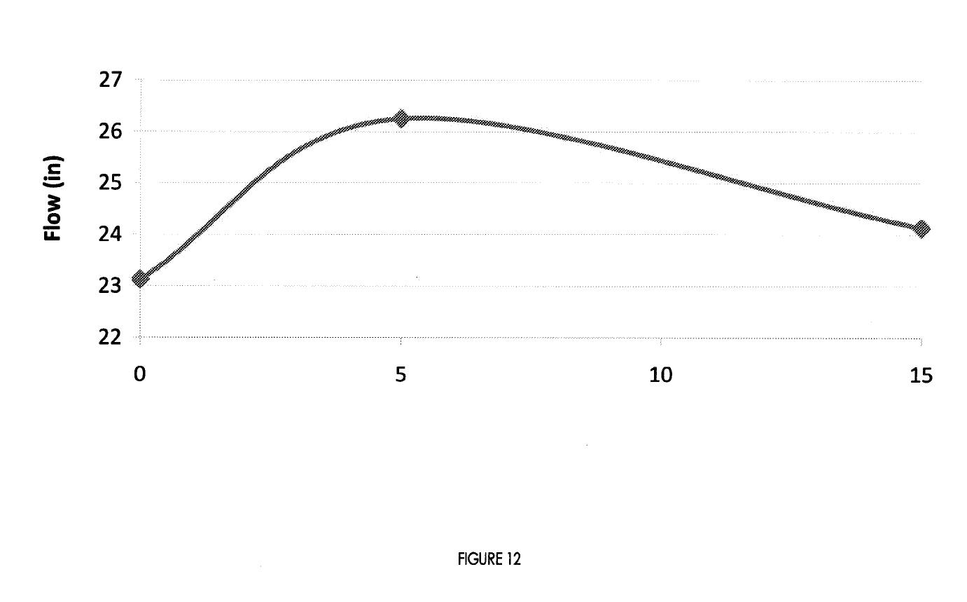

The J-ring slump flow (Table 21, FIG. 12) of the investigated SCC mix was in the range of 580 mm to 655 mm, and the slump was in the range of 260 mm to 270 mm. FIG. 12 shows the J-ring test results of SCC with different dosages of SCCP. All SCC mixtures presented a slump flow between 500 mm and 700 mm, which is an indication of a good deformability. It should be noted, however, that to obtain the aforementioned properties, the SCC mixtures required a relatively high dosage of HRWRA and application of nano-SiO₂ (Table 21). The use of 5% of SCCP in SCC significantly improved the flow (655 mm vs. 580 mm flow of reference SCC) as it was expected.

### Mechanical Properties

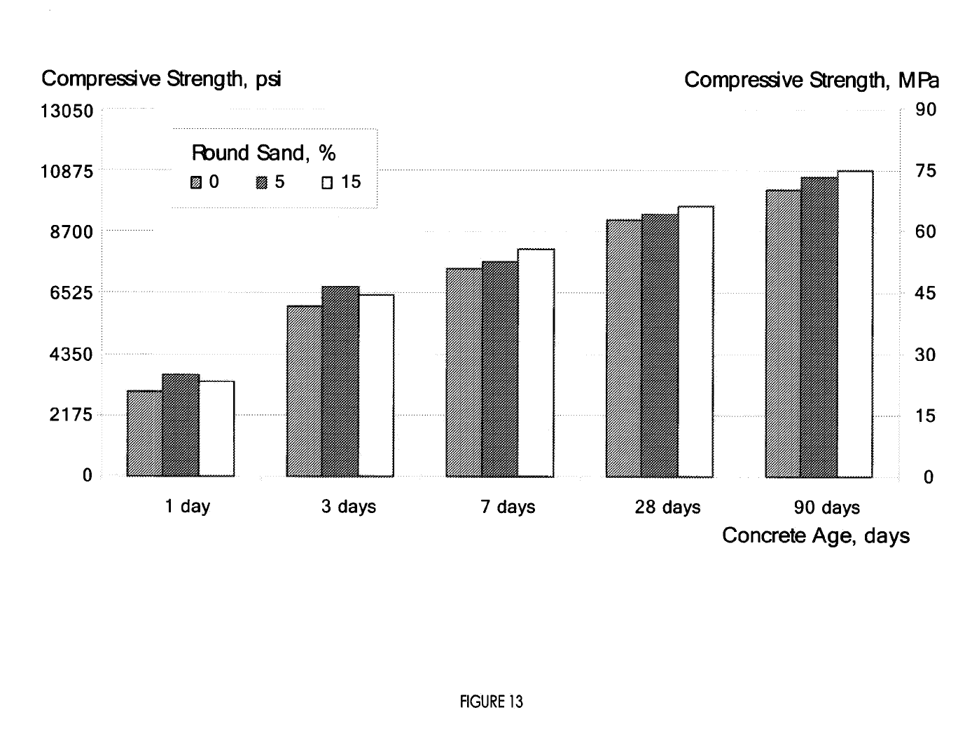

The compressive strength of the different SCCs is shown in Table 21 and FIG. 13. FIG. 13 shows the effect of SCCP on compressive strength of SCC. The control concrete (R0) developed lesser compressive strengths vs. SCC with different dosages of SCCP at all ages of hardening. SCC with 5% of SCCP (R1) had remarkable 1-day strength, 25 MPa (3616 psi) which is 19% higher than reference (R0). Replacement of natural sand with 15% of SCCP (R3) had resulted in 6%-11% strength increase in all ages of hardening (vs. reference R0). However, the observed strength difference between the concrete with SCCP and reference concrete is reduced at later ages of hardening (28+ days), FIG. 13.

TABLE 21
Fresh properties and compressive strength of SCC

| | Slump, | J-ring | Unit Weight, | Average SCC Compressive Strength, | | | | |
|---|---|---|---|---|---|---|---|---|
| SCCP | mm | flow, | kg/m³ | MPa (% of reference)/psi at age of: | | | | |
| (%) | (in) | mm (in) | (lb/yd³) | 1 day | 3 days | 7 days | 28 days | 90 days |
| 0 | 260 | 580 | 2190 | 21.0 | 41.6 | 50.7 | 62.7 | 70.3 |
| | (10.5) | (23) | (3684) | 3040 | 6032 | 7347 | 9088 | 10187 |
| 5 | 270 | 655 | 2190 | 24.9 | 46.4 | 52.6 | 64.2 | 73.2 |
| | (11) | (26) | (3684) | (19%) | (12%) | (4%) | (2%) | (4%) |
| | | | | 3616 | 6729 | 7631 | 9310 | 10607 |
| 15 | 260 | 605 | 2210 | 23.3 | 44.4 | 55.7 | 66.2 | 75.0 |
| | (10.5) | (24) | (3717) | (11%) | (7%) | (10%) | (6%) | (7%) |
| | | | | 3384 | 6435 | 8076 | 9598 | 10871 |

### CONCLUSIONS

Based on the test results, the following conclusions can be drawn:

1) It is possible to produce effective SCC using optimal aggregates proportioning, application of superplasticizer and nano-SiO₂ with a J-ring slump flow in the range of 580 mm to 655 mm and the slump in the range of 260 mm to 270 mm.

2) The conducted investigation demonstrates that the replacement of natural sand with synthetic calcium carbonate pellets, SCCP results in SCC with enhanced flow properties (increase of J-ring slump flow from 580 to 655 mm or by 14%) and improved compressive strength (by 6-11%), especially in early age (up to 19%). The observed performance improvement is an important feature related to the application of round sand which could possibly be effectively used in many practical applications (SCC, self-leveling screeds, pumpable concrete, oil-well mixtures, etc).

We claim:

1. A method of treating water, the method comprising:
providing water including a principal ion and a target element;
contacting the water with a fluidized bed, the fluidized bed including seed material; and
controlling at least one of a type and a size of the seed material to remove principal ion and target element from the water.

2. The method of claim 1, wherein the providing act includes doping the water with principal ion.

3. The method of claim 2, wherein the doping act includes, before the contacting act, doping the water with an amount of principal ion.

4. The method of claim 2, wherein the doping act includes doping the water with an amount of principal ion in the fluidized bed.

5. The method of claim 2, and further comprising removing the doped principal ion.

6. The method of claim 1, and further comprising:
introducing a reagent to the water; and
controlling at least one of a type and an amount of the reagent introduced to remove the target element from the water.

7. The method of claim 6, wherein the introducing act includes, before the contacting act, introducing a reagent to the water so as to have a substantially complete heterogeneous nucleation take place on the seed material.

8. The method of claim 6, wherein the introducing act includes introducing a reagent to the water in the fluidized bed.

9. The method of claim 8, wherein the introducing act includes
introducing a reagent to the water at a first level in the fluidized bed, and
introducing a reagent to the water at a second level in the fluidized bed.

10. The method of claim 9, wherein the reagent introduced to the water at the first level is the same as the reagent introduced to the water at the second level.

11. The method of claim 9, wherein the reagent introduced to the water at the first level is different than the reagent introduced to the water at the second level.

12. The method of claim 1, and further comprising:
discharging treated water having a concentration of the target element;
determining whether the concentration of the target element in the treated water is above a threshold; and
if the concentration of the target element in the treated water is above the threshold, recirculating the water to the fluidized bed for further treatment until the concentration of the target element is one of equal to and less than the threshold.

13. The method of claim 1, and further comprising crystallizing principal ion from the water on a nano-scale to form a principal ion carbonate crystalline lattice, the target element being incorporated into the principal ion carbonate crystalline lattice.

14. The method of claim 13, wherein the target element includes radium, the radium being incorporated into the principal ion carbonate crystalline lattice.

15. The method of claim 13, wherein the crystallizing act includes producing a pellet including a seed material, target element carbonate crystals, and principal carbonate crystals.

16. The method of claim 15, wherein the target element includes radium, and wherein the pellet includes radium carbonate crystals.

17. The method of claim 15, wherein the fluidized bed is provided in a reactor vessel, and wherein the method further comprises removing pellets from the reactor.

18. The method of claim 17, and further comprising adding seed material to the fluidized bed.

19. The method of claim 1, wherein the target element includes radium.

20. The method of claim 19, and further comprising discharging treated water having a combined activity from Ra-226 and Ra-228 of less than about 5 pCi/L.

21. The method of claim 19, and further comprising discharging treated water having a radium concentration at least about 90% less than a radium concentration in the water.

22. The method of claim 1, wherein the principal ion includes calcium.

23. The method of claim 22, and further comprising crystallizing calcium from the water on a nano-scale to form a calcium carbonate crystalline lattice, the target element being incorporated into the calcium carbonate crystalline lattice.

24. The method of claim 23, wherein the target element includes radium, the radium being incorporated into the calcium carbonate crystalline lattice.

25. The method of claim 1, wherein the principal ion includes magnesium.

26. A method of removing radium from water, the method comprising:
contacting water including radium with a fluidized bed, the fluidized bed including a seed material; and
controlling at least one of a type and a size of the seed material to remove radium from the water.

27. The method of claim 26, and further comprising:
introducing a reagent to the water; and
controlling at least one of a type and an amount of the reagent introduced to remove radium from the water.

28. The method of claim 27, wherein the introducing act includes
introducing a reagent to the water at a first level in the fluidized bed, and
introducing a reagent to the water at a second level in the fluidized bed.

29. The method of claim 26, and further comprising:
discharging treated water having a concentration of radium;
determining whether the concentration of radium in the treated water is above a threshold; and
if the concentration of radium in the treated water is above the threshold, recirculating the water to the fluidized bed for further treatment until the concentration of radium is one of equal to and less than the threshold.

30. The method of claim 26, and further comprising discharging treated water having a combined activity from Ra-226 and Ra-228 of less than about 5 pCi/L.

31. The method of claim 26, and further comprising discharging treated water having a radium concentration at least about 90% less than a radium concentration in the water.

32. The method of claim 26, wherein the water also includes calcium, and wherein the controlling act includes controlling at least one of a type and a size of the seed material to remove calcium from the water.

33. The method of claim 32, and further comprising adding calcium to the water.

34. The method of claim 32, and further comprising crystallizing calcium from the water on a nano-scale to form a calcium carbonate crystalline lattice, radium being incorporated into the calcium carbonate crystalline lattice.

35. The method of claim 34, wherein the crystallizing act includes producing a pellet including a seed material, radium carbonate crystals, and calcium carbonate crystals.

36. The method of claim 35, wherein the fluidized bed is provided in a reactor vessel, and wherein the method further comprises removing pellets from the reactor.

37. A pellet produced by a process comprising:
contacting water including calcium and radium with a fluidized bed, the fluidized bed including a seed material;
controlling at least one of a type and a size of the seed material to remove calcium and radium from the water; and
crystallizing calcium from the water on a nano-scale to form a calcium carbonate crystalline lattice, radium being incorporated into the calcium carbonate crystalline lattice, the crystallizing act including producing a pellet including a seed material, radium carbonate crystals, and calcium carbonate crystals.

38. Water treated by a process, the treated water having a radium concentration at least about 90% less than a radium concentration in the water before treatment, the treated water having a combined activity from Ra-226 and Ra-228 of less than about 5 pCi/L.

39. A method for controlling the amount of at least one target element removed from water and the amount of at least one target element in a pellet, the method comprising selecting a desired concentration of target element cation A in the pellets, Aₚ, and controlling a fraction of the pellet weight formed from a seed material fₛ and a fraction of the pellet weight formed from chemical reagents f_{c} by using the following formula:
$${f}_{s} + {f}_{c} = 1 - \frac{{A}_{p} {C}_{ca \text{/} Mg}}{{B}_{A}} ,$$
wherein C_{Ca/Mg} is volumetric calcium or magnesium concentration in the water and B_{A} is the target element concentration in the water.
